(19) United States
(12) Patent Application Publication
(10) Pub. No.: US 2025/0141331 A1
(43) Pub. Date: May 1, 2025

(54) SUPERCONDUCTING BRUSHLESS COMMUNTATORLESS DC ELECTRICAL MOTOR AND GENERATOR

(71) Applicant: Emanuel Edwin Shah, Austin, TX (US)

(72) Inventor: Emanuel Edwin Shah, Austin, TX (US)

(21) Appl. No.: 18/170,653

(22) Filed: Feb. 17, 2023

Related U.S. Application Data
(63) Continuation-in-part of application No. 16/688,035, filed on Nov. 19, 2019, now abandoned.

(51) Int. Cl. H02K 55/04

(52) U.S. Cl. CPC H02K 55/04

(57) ABSTRACT

A superconducting brushless communtatorless DC electrical motor and generator includes a machine housing, a first stationary member, a first rotating member, a second stationary member, a second rotating member, a shaft, a power transfer device and a cooling assembly. In generator mode it is capable of generating transmission level DC voltages for DC transmission. In the motor mode the machine produces a magnetic field where at least one coil side produces main driving torque and the remaining coil sides produce torque that is either in the same direction as the coil side producing main driving torque or in opposite direction to the coil side producing main driving torque or has no effect on the torque produced by the coil producing main driving torque. This enables the final torque as a result of combined effect of torque produced by all the coil sides and producing continue rotation.

This U.S. patent application is continuation-in-part of pending U.S. application Ser. No. 16/688,035, filed on Nov. 19, 2019.

### BACKGROUND

### 1. Field of the Invention

The present invention relates generally to electrical machine systems, and more specifically, to a superconducting brushless communtatorless DC electrical motor and generator system.

### 2. Description of Related Art

Electrical machine systems are well known in the art with different types of brushless and brush type machines with different definitions of construction and performance.

Superconducting field coils with conventional copper stator has been the norm for the industry since the superconducting technology has been available. This topology offers great performance and other advantages over conventional machines but with several limitations. This topology offers the air gap sheer stress in the range between 30 psi and 100 psi. When superconducting windings are used in both stator and rotor the current values are increased by a factor of 100 or more in rotor windings. This allows much higher airgap sheer stress along with higher magnetic loading achievable with fully cryogenic machine architecture. The direct result of this innovative architecture is higher power density and superior performance. The new innovative design allows the use of superconducting coils in both stator and rotor construction. This DC architecture also eliminates AC losses in the two windings. This will result in increased power density, superior performance and lower cost not achievable with existing superconducting machines with copper stator coils.

Another important feature of the new machine architecture is that the rotor conductors are active during the entire 360 degrees of rotation. This novel DC architecture of the machine also allows high torque density. Depending upon the type of motor design these two important features are not possible in existing motor designs. One skilled in the art can understand this problem. The direct result of this is further increase in power and torque density and further reduction in cost.

Accordingly, although great strides have been made in the area of electrical machine systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1 and 1A shows a superconducting coil;

FIG. 2A shows a triangular coil;

FIGS. 2B and 2C shows a right-angled multisided coil;

FIGS. 3 and 3A shows a principle of motor action with rotor coil perpendicular to shaft and stator coil according to the present application;

FIGS. 4 and 4A shows the principle of motor action with rotor coil parallel to stator coil according to the present application;

FIG. 4B shows the principle of motor action with rotor coil parallel to stator coil according to the present application;

FIGS. 5 and 5A shows the principle of motor action with rotor coil provided with right angle extension according to the present application;

FIGS. 6 and 6A shows a construction and integrated assembly of a superconducting motor with rotor coils perpendicular to a stator coil;

FIGS. 7 and 7A shows the construction and integrated assembly of the superconducting motor with rotor coil parallel to stator coil;

FIGS. 8 and 8A shows the construction and integrated assembly of the superconducting motor with rotor coils with right angle extension;

FIG. 9 shows the connection scheme for separately excited motor using Liquid metal rotating contacts (LMRC);

FIG. 10 shows the connection scheme for separately excited motor using rotatable switch mode transformer (RSMT);

FIG. 11 shows the connection scheme for a DC shunt motor utilizing liquid metal rotating contact (LMRC);

FIG. 12 shows the connection scheme for DC shunt motor using rotatable switch mode transformer (RSMT);

FIG. 13 shows the connection scheme for DC shunt motor using rotatable switch mode transformer (RSMT) where both the armature and the shunt field are provided with variable DC power;

FIG. 13A shows the connection scheme for DC shunt motor using LMRC;

FIG. 14 shows the connection scheme for DC shunt motor using AC transformer;

FIG. 15 shows the connection scheme for a DC series motor utilizing liquid metal rotating contact (LMRC);

FIG. 16 shows the connection scheme for a DC series motor utilizing RSMT;

FIG. 17 shows the connection scheme for a DC compound motor utilizing LMRC;

FIG. 18 shows the connection schematic for a superconducting DC generator according to the present application;

FIGS. 19 and 19A shows the principle of generator action according to the present application;

FIGS. 20 and 20A show the construction and integrated assembly of a superconducting DC generator;

FIGS. 21, 21A and 21B show embodiments of coils;

FIG. 22 shows a bifurcated triangular coil;

FIG. 23 shows a bifurcated coil is used in the rotating armature;

FIGS. 24 and 24A show the construction and integrated assembly of an iron core armature, permanent magnet motor with bifurcated armature coils perpendicular to the stator;

FIGS. 25 and 25A show the construction and integrated assembly of an iron core armature, wound stator motor with bifurcated armature coils perpendicular to the stator;

FIGS. 26 and 26A show a bifurcated coil is used in the rotating armature with cylindrical rotor;

FIGS. 27 and 27A show the construction and integrated assembly of an iron core armature, cylindrical permanent magnet motor with bifurcated armature coils where shaft is parallel to the cylindrical stator;

FIGS. 28 and 28A show the construction and integrated assembly of an iron core armature, cylindrical wound stator motor with bifurcated armature coils perpendicular to the stator;

FIGS. 29 and 29A shows operating principles of linear motors;

FIG. 30 shows an embodiment of a linear motor where the plane of the armature coils is perpendicular to the stator coil;

FIGS. 31 and 31A shows the construction and integrated assembly of a superconducting DC linear motor;

FIG. 32 shows the construction and integrated assembly of an iron core armature, permanent magnet stator linear motor with triangular armature coils perpendicular to the stator;

FIGS. 33, 33A, 34, 34A, 34B and 34C describes the embodiments of a motor with two stator coils with poles of like polarity interacting with rotor coils.

FIGS. 35 and 35A show the principle of motor action plane of the rotor coil perpendicular to shaft and to stator coil according to the present application.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional electrical machine systems. Specifically, the present application discloses an innovative magnetic field circuit generated by a single stator coil with special characteristics linking at least one rotor coil with special characteristics through airgaps. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

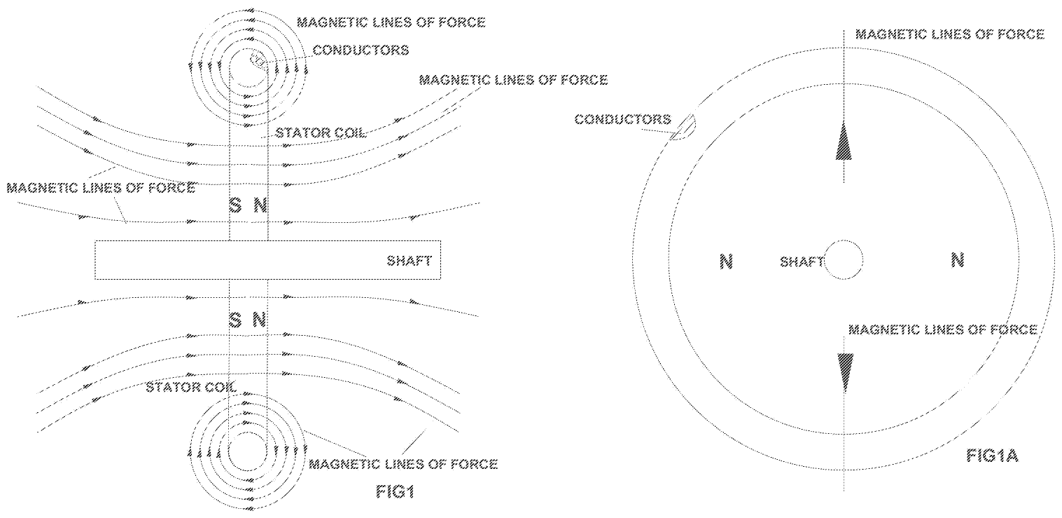

Referring now to the drawings wherein like reference characters identify corresponding or similar elements throughout the several views, FIG. 1 depicts a superconducting coil of a superconducting brushless communtatorless DC electrical motor and generator system in accordance with a preferred embodiment of the present application. It will be appreciated that the system overcomes one or more of the above-listed problems commonly associated with conventional electrical machine systems.

### DC Superconducting Reversible Motor and Generator Electrical Machine

In the contemplated embodiment, FIG. 1 shows a superconducting coil 1 which may be used for both motor action and generator action. The coil 1 is wound with superconducting wires and when excited by a DC current the coil 1 may generate a magnetic field as shown in FIG. 1. Magnetic lines of force may originate from the North Pole and return to the South Pole as shown in FIG. 1.

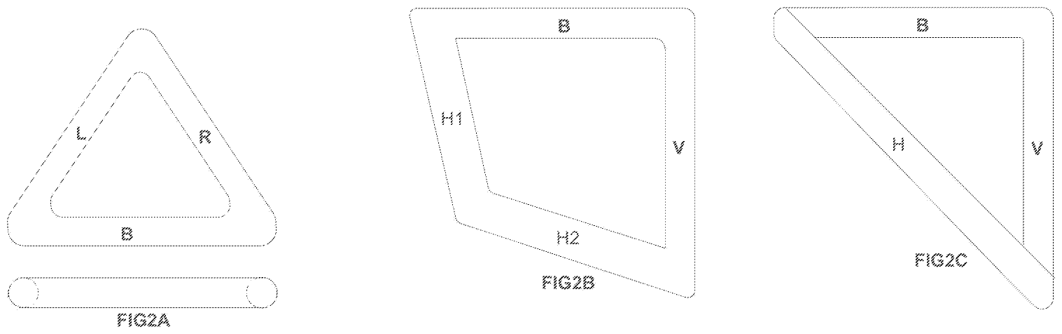

FIG. 2A shows a triangular coil and FIGS. 2B and 2C show right angled multisided coils. These two superconducting coils may be used for both motor action and generator action. FIG. 2A shows a triangle coil with coil sides B, L and R denoting three sides of the coil.

FIGS. 2B and 2C show right angled multisided coil with coil sides B, V and two sections H1 and H2 formed by bending the sections H1 and H2 at right angle to the plane of coil sides B and V.

Although the description may describe two main coil types, it should be appreciated that it may be possible to design different coil types based on the principles of the present application. The primary design goal of the coil is to generate torque by using the coil sides that rotate a shaft and cancel torques produced by the coil sides that oppose the torque on the shaft.

Operating Principles of Superconducting DC Motor with Rotor Coils Perpendicular to the Stator Coil

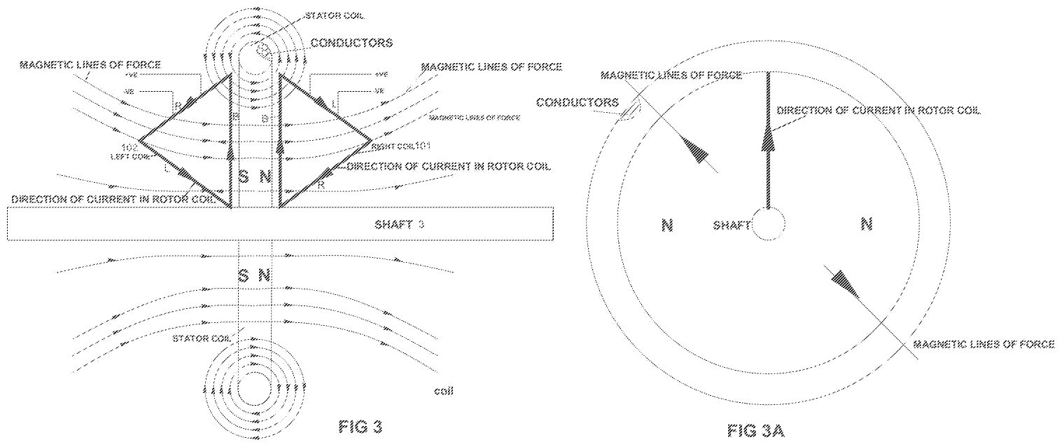

FIGS. 3 and 3A show a principle of motor action according to the present application. For the motor action the term stator and field and rotor and armature are used interchangeably. A stationary stator coil 2 may generate a magnetic field as shown in FIGS. 3 and 3A.

A rotating shaft 3 may be assembled as shown in FIGS. 3 and 3A. Two coils 101 and 102 as shown in FIG. 2A with sides B, L and R are mounted on the shaft as shown in FIGS. 3 and 3A. Only two coils are shown to describe the principle of operation, but in actual practice a large number of coils may be assembled to meet desired specifications. These coils link the magnetic field generated by the stator coil 2.

When the rotor coils 101 and 102 are supplied with DC current and with the direction of current as shown in FIGS. 3 and 3A the following actions take place.

Applying Fleming's left-hand rule of the motor action to sides B of the coils 101 and 102 which are perpendicular to the shaft 3, it will be observed that this action will cause the shaft 3 to rotate when forces are generated on the coil sides B. The coil sides L and R of coils 101 and 102 will tend to rotate the shaft 3 depending on the direction of current in each coil side and the direction of the magnetic field which links these sides. The direction of torque produced by each coil side may be determined by the Fleming's left hand rule of motor action and this action may produce a final rotational effect on the rotation of the shaft 3.

When a selected force has a magnitude and a direction, it is defined as a vector quantity and the selected force assumes vector properties. it is known in prior art that a vector quantity can be resolved into a X-component along X-axis and a Y component along the Y-axis. Accordingly, force produced by coil side B can be resolved in to X component along selected x-axis and to Y component along selected Y-axis.

In a similar manner the force produced by the coil sides L and R can be resolved into a X-component along X-axis and a Y component along the Y-axis.

In this embodiment the force produced by coil sides B, L and R have active component only along the X-axis. The component along the Y-axis is zero. It is therefore important to resolve force in only along the X-axis which is only one direction. It will not be necessary to include Y-component in the calculation of the torque.

The coil sides L and R of coils 101 and 102 may rotate the coil and exert rotational force on the shaft depending on the direction of current in each coil side and the direction of the magnetic field linked by these sides. The direction of torque produced by each coil side may be determined by the Fleming's left-hand rule of motor action and this action may produce final rotational effect on the rotation of the shaft 3.

Observing coils 101 and 102 from right to left towards the center of the shaft 3, the direction of current in the coils 101 and 102 may be as shown in FIGS. 3 and 3A. Applying the Fleming's left hand rule of motor action, the coil side L of coil 101 may generate the rotation of the coil in anticlockwise direction and simultaneously the coil side R of coil 102 may also generate rotation of the coil in anticlockwise direction. These two rotational forces is in the opposite direction of the force produced by side B of coil 101 and 102.

In a similar manner applying the Fleming's left hand rule of motor action to the coil side R of coil 101 may generate a rotation of the coil in clockwise direction while simultaneously the coil side L of coil 102 may generate rotation of the coil in anticlockwise direction. These two rotational forces is in the opposite direction of the rotational force produced by side B of coil 101 and 102.

It may be observed that the rotational torque produced by coil sides L and R of coils 101 and 102 may be in opposite direction to the rotational torque produced by side B of coils 101 and 102. The final rotational force exerted on the shaft or the torque produced by coils 101 and 102 will be the difference between the torque produced by coil sides B of coils 101 and 102 and the torque produced by coil sides L and R of coils 101 and 102.

Selecting a flux density generated by stator coil 3 and the number of turns of stator and rotor coils and dimensions of sides B, L and R the motor may be able to produce desired values of torque, speed and power output of the motor. The fully cryogenic design of the motor and generator may eliminate rotor coupling for refrigerant and associated cost, reliability problems and maintenance involved.

It may be observed that power output and power density available with the present application is much higher than the prior art. These design concepts and fully cryogenic refrigeration may produce double the power density and thus power output of a motor of similar size available in the prior art.

### HTS 2G Superconducting Wires for Superconducting DC Motor and Generator

2G HTS wires are new development in superconducting wire technology. They are able to achieve superconducting properties above the boiling point of liquid nitrogen. The actual operating temperatures of the electrical machines using 2G HTS wires according to the present invention depends upon the characteristics of the magnetic and electrical circuits and fields. They are available in different chemical compositions primarily they are identified as YBCO, BSCCO and REBCO superconductors. These superconductors are well suited for application in electrical machines.

Construction and Assembly of Superconducting DC Motor with Rotor Coils Perpendicular to the Stator Coil

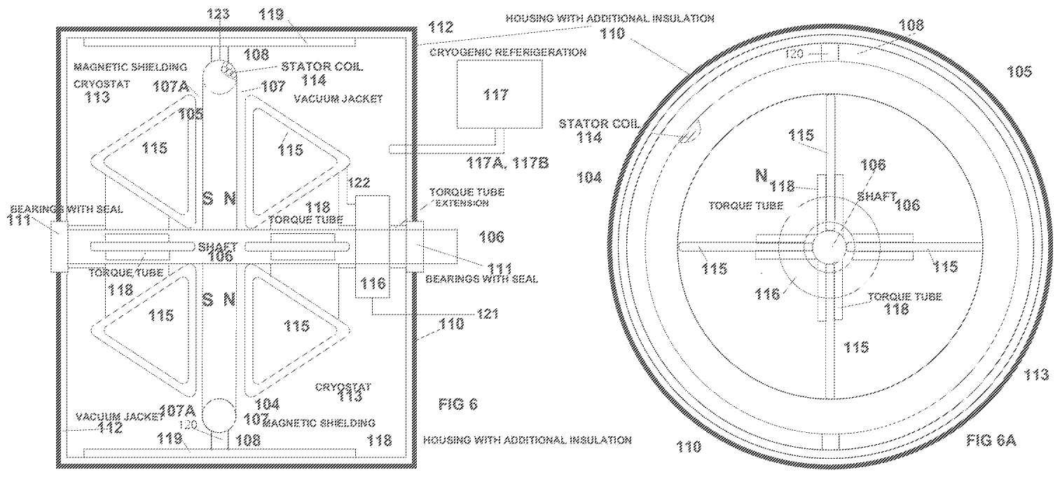

FIGS. 6 and 6A show a construction and integrated assembly of a superconducting motor with rotor coils perpendicular to a stator coil.

The motor includes a stator assembly 104 and a rotor assembly 105. The rotor assembly 105 is mounted on a rotating shaft 106 and the rotor assembly rotates as it magnetically links the stator assembly 104 by airgaps 107 and 107A. The magnetic field produced by one pole of the stator coil may be returned to the other pole by flux return path 108. The stator assembly may be supported by stator supports 109. Both the stator assembly 104 and rotor assembly 105 are mounted inside a motor housing 110. The rotating shaft 106 may be located on the housing by two bearings 111 as shown in FIGS. 6 and 6A. The bearings may be either insulted from the housing or designed to operate in cryogenic environment. A vacuum jacket 112 having an inner vessel and an outer vessel with extra insulation creates a structure within the housing 110. The stator assembly 104 and rotor assembly 105 may be mounted inside this structure. This structure may be defined as low temperature cryostat 113. The function of the cryostat 113 is to maintain superconducting temperatures for the stator coil 114 and rotor coils 115 to maintain superconducting properties to conduct superconducting currents and maintain flux. The low temperature cryostat 113 makes use of the latest technology available for the design of cryostats. The vacuum jacket is designed to maintain selected vacuum properties for the life of the superconducting motor or a generator. For smaller rating motors and generators, the vacuum jacket is fabricated from stainless steel. However, for high power applications, the vacuum jacket is fabricated from a nonmagnetic composite material such as a fiber reinforced epoxy, either by filament winding or by manually. In one embodiment, the inner and outer vessels of the vacuum jacket are fabricated of a non-magnetic composite material.

Both the stator coil 114 and rotor coils 115 may be wound with HTS 2G superconducting wires. This may allow motor operation at or below 77K.

The technology for materials used in electrical machines has advanced to a great extent and several different types of material available for design of various components of the motor has increased. The stator housing 110 can be made from black iron, steel, aluminum alloys or for larger machines titanium alloys.

Installed on the shaft 106 is a rotor power unit (RPU) 116. The RPU 116 has a rotating member and a stationary member. The stationary member is mounted on the housing 110 and the rotating member is mounted on the shaft 106. DC or AC power may be applied to the stationary member of the RPU 116 and electrical power may be transferred to the rotating member electromagnetically. The output of the rotating member may be connected to the rotor coils 115. The rotor coils 115 may be connected in series or parallel to the output of the RPU 116 to obtain a desired result.

Since high air gap sheer stresses may be generated this may result in high mechanical forces on the rotor coils 115. Therefore, it may be important to wind the rotor coils 115 in a high strength coil former made from high strength suitable material such as stainless steel and impregnated with epoxy resins. The input to the rotor coils may be DC.

A closed loop cryogenic refrigeration system 117 as shown in FIGS. 6 and 6A may be located outside the motor housing and connected to the cryostat by refrigerant transfer tube 117A and return tube 117B as shown in FIGS. 6 and 6A. The cryogenic refrigeration system 117 conducts heat from the rotor coils 115 and stator coil 114 to the cryogenic refrigeration system 117, where the heat is dissipated. Cryogenic refrigeration system 117 maintains superconducting temperatures inside the cryostat 113 by circulating cryogenic refrigerant at superconducting temperatures. This keeps the stator coil 114 and rotor coils 115 in the superconducting state. The cryogenic refrigeration system 117 is available from the manufactures of the systems and the rating of the refrigeration system depends upon the design of the motor and the generator.

The rotor coils 115 are connected to the rotor shaft 106 by a torque tube 118 and the outer surface of the torque tube 118 may form the support structures for the rotor coils 115. The function of torque tube 118 is to transfer the torque produced by the rotor coils 115 to the shaft 106. The torque tube 118 also acts as a heat shield between the cryostat and the shaft 106 exposed to outside warm temperatures. This reduces the thermal load on cryogenic refrigeration system. The separate sections of the shaft 106 where coil is not mounted contains torque tube extensions 118A which also insulates cryostat from the sections of shaft 106 exposed to warm temperatures.

Torque tube 118 is a very important component of the machine and can be fabricated from Inconel or any other suitable material with high mechanical strength and low thermal conductivity to prevent heat transfer to cryogenic components.

An electromagnetic shield 119 may be fabricated around the stator assembly 114 and attached to vacuum jacket 112. The stator assembly 114 may be secured to the housing by stator supports 120.

Under the description of operating principles for rotor coils 115 perpendiculars to the stator coil 114 is described in detail how different electromagnetic mechanisms generate the required torque for the rotor coils 115.

For the motor operation to take place, the rotor coils 115 may have to connect to the stator coil 114 and the stator coil 114 powered from PSS and rotor coils 115 powered from RPU 116.

Operating Principles of Superconducting DC Motor with Rotor Coils Parallel to the Stator Coil

AS explained in the specification the electromagnetic force created by an armature coil side by the interaction between the armature current and stationary magnetic field has a magnitude and a direction. The magnitude and the direction of the rotational force or torque exerted on the shaft by each coil side are calculated by the formula presented in the following description.
Magnitude of the electromagnetic force produced by each coil side
is given by the formula, F=B×I×L
Where F=force in Newtons
B=flux density in tesla
I=current in ampere
N=no of turns in coil
l=length of each coil side in meters
L=N×l in meters

The direction of the electromagnetic force is given by Fleming's left-hand rule of motor action.

When a selected force has a magnitude and a direction, it is defined as a vector quantity and the selected force assumes vector properties. it is known in prior art that a vector quantity can be resolved into a X-component along X-axis and a Y component along the Y-axis.

There are two types of embodiments presented in the present invention. In one type of embodiment the electromagnetic force produced by a coil side acts only along one axis. The force can act along X-axis or Y-axis. The force along the second axis is zero. An example this embodiment is illustrated in FIGS. 33,33A and 34,34A.

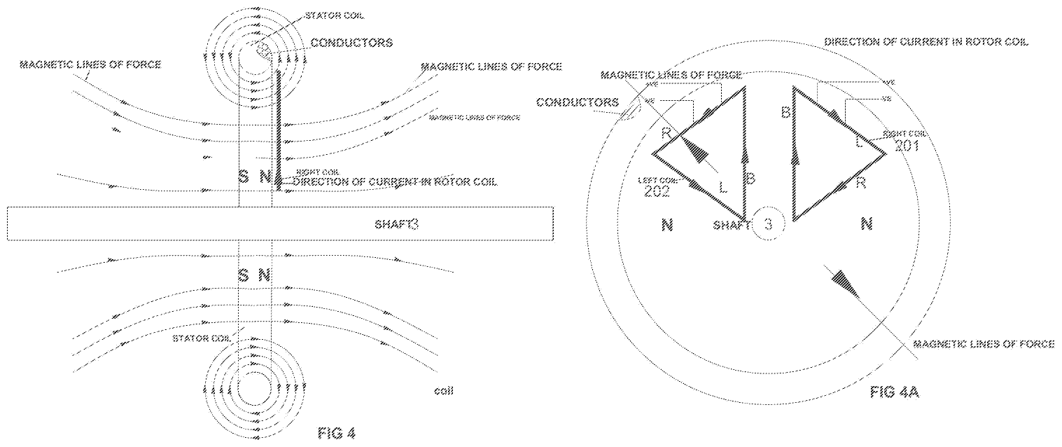

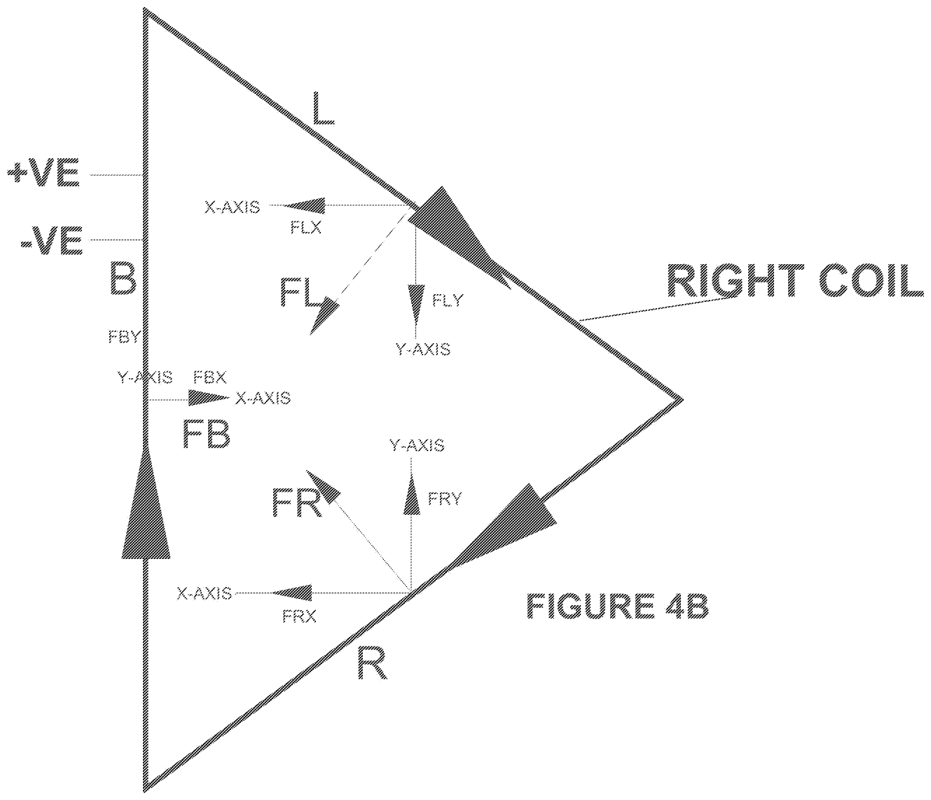

In the second type of embodiment the electromagnetic force produced by a coil side act in a manner whereby the force can be resolved along both of the two axes. Thus, the force can be resolved along selected X-axis and Y-axis. An example this embodiment is illustrated in FIGS. 4,4A and 4B.

FIGS. 4, 4A and 4B show how a electromagnetic force generated by a coil side can be resolved along selected X-axis and Y-axis.

The coil side produces force with the magnitude defined by the force formula presented earlier and the direction of the force is determined by the Flemings left hand rule of motor action.

Also is shown the selected X-axis and Y-axis along which the electromagnetic force produced by the right-hand side coil is resolved. This illustrates the two components of the force produced by selected coil side.

In a similar manner the electromagnetic force produced by the remainder of the coil sides is also resolved along their selected X-axis and Y-axis producing components of force generated by each coil side along their selected X-axis and Y-axis.

The final force created by the entire selected coil that produces torque on the shaft is resultant force created by the addition of X components and Y components of all the sides of the entire coil. First the X component of the selected coil side is added to the X components of the remainder of the coil sides. Then the Y component of the selected coil side is added to the Y components of the remainder of the coil sides. Finally, the selected coil side produces primary torque and the X and Y components of the remainder of the coil sides in the coil produces force depending on their magnitude and direction.

These force details are presented in FIGS. 4, 4A and 4B. FIG. 4B is an extension of FIGS. 4 and 4A. The direction of the stator magnetic field and the direction of the current in the coil are same as shown in FIGS. 4 and 4A. FIG. 4B shows the forces created by the right-hand side coil. The interaction of magnetic field created by the stator and the current in the coil is as shown in FIGS. 4 and 4A.

Referring to FIG. 4B, the force created by the selected coil side L is as follows:
1. The force created by the coil side L is denoted by FL

And the component of force created along the X-axis is denoted by FLX and the component of force created along the Y-axis is denoted by FLY
1. The force created by the coil side R is denoted by FR

And the component of force created along the X-axis is denoted by FRX and the component of force created along the Y-axis is denoted by FRY.
1. The force created by the coil side B is denoted by FB

And the component of force created along the X-axis is denoted by FBX and the component of force created along the Y-axis is denoted by FBY.

When a X or Y component of the electromagnetic force is acting in the same direction as the X or Y component of the electromagnetic force generated by selected coil side, it is given a positive value.

Then the component of the electromagnetic force acting in the opposite direction to X or Y component of the selected coil side is given a negative value.

The rotational force exerted on shaft producing torque on the shaft created by each coil side depends upon the length of each coil side and the shape of the selected coil and the position with respect to the stator magnetic field. When the length of coil side B is much greater than the coil sides L and R the main driving force producing the torque is produced by coil side B

When the length of coil sides L and R is much greater than the length of the coil side B, the main driving force producing the torque is produced by coil sided L and R.

Referring to FIG. 4B the force component along the Y axis of side B is 0. And the X component of side B is given by formula presented earlier.

The X&Y components of the force produced by sides L and R, are as shown in FIG. 4B.

When the rotor coils 201 and 202 are supplied with DC current and with the direction of current as shown in FIGS. 4, 4A and 4B the following actions take place, Applying Fleming's left hand rule of the motor action to side B of the coils 201 and 202 which are perpendicular to the shaft 3 it may be observed that his action causes the shaft to rotate when forces are generated on the coil sides B. The direction of the force is given by Fleming's left hand rule of motor action.

When a selected force has a magnitude and a direction, it is defined as a vector quantity and the selected force assumes vector properties. it is known in prior art that a vector quantity can be resolved into a X-component along X-axis and a Y component along the Y-axis. Accordingly force produced by coil side B can be resolved in to X component along selected x-axis and to Y component along selected Y-axis.

In a similar manner the force produced by the coil sides L and R can be resolved into a X-component along X-axis and a Y component along the Y-axis. The coil sides L and R of coils 201 and 202 may rotate the coil and not the shaft depending on the direction of current in each coil side and the direction of the magnetic field linked by these sides. The direction of torque produced by each coil side may be determined by the Fleming's left hand rule of motor action and this action may produce final rotational effect on the rotation of the shaft 3. Looking at coils 201 and 202 from right to left towards the center of the shaft 3 the direction of current in the coils 201 and 202 may be as shown in FIGS. 4, 4A and 4B. Applying Fleming's left hand rule of motor action, the coil side L of coil 201 may generate force with Y component of the force generating the rotation of the coil in clockwise direction while simultaneously the with Y component of the force generating the rotation of the coil in coil side R of coil 201 may generate the rotation of the coil in anticlockwise direction. These two rotational forces are in opposite direction and may cancel each other and produce a net rotational force exerted on the shaft of zero. In a similar manner, Applying the Fleming's left hand rule of motor action to the coil side R of coil 202 may generate force with Y component of the force generating the rotation of the coil in clockwise direction while simultaneously the with Y component of the force generating the rotation of the coil in coil side R of coil 201 may generate the rotation of the coil in anticlockwise direction. These two rotational forces are in opposite direction and may cancel each other and produce a net rotational force exerted on the shaft of zero. It may be observed that the Y component of rotational force produced on coil sides L and R of coils 201 and 202 may cancel each other and the resultant torque produced by coils 201 and 202 may be the torque produced by the X components of coil sides L and R of coils 201 and 202 and the X component of coil sides B of coils 201 and 202. Selecting a flux density generated by stator coil 3 and the number of turns of stator and rotor coils and dimensions of the sides B, the motor may be able to produce desired values of rotational force exerted on shaft or torque, speed and power output of the motor. The fully cryogenic design of the motor and generator may eliminate rotor coupling for refrigerant and associated cost, reliability problems and maintenance involved.

It may be observed that power output and power density available with the present application is much higher than the prior art superconducting motors and generators. These design concepts and fully cryogenic refrigeration may produce more than double the power density and thus power output of a motor of similar size available in the prior art superconducting motors and generators.

Construction and Assembly of Superconducting DC Motor with Rotor Coils Parallel to the Stator Coil

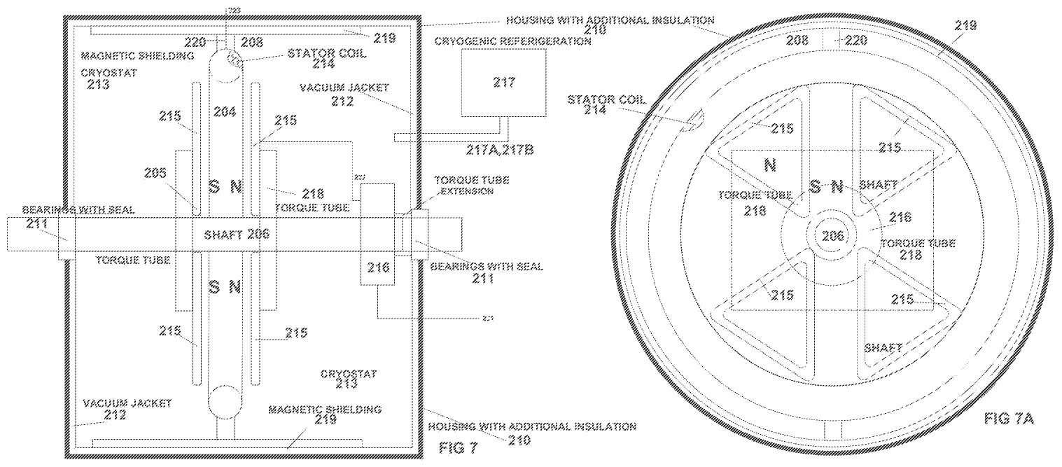

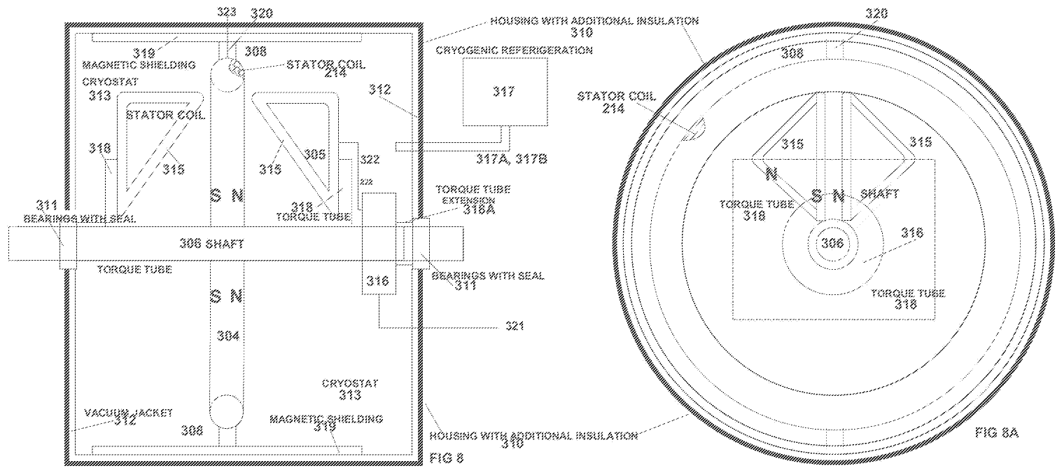

FIGS. 7 and 7A show the construction and integrated assembly of a superconducting motor and rotor coils parallel to the stator coil.

The motor includes a stator assembly 204 and a rotor assembly 205. The rotor assembly 205 may be mounted on a rotating shaft 206 and the rotor assembly rotates as it magnetically links the stator assembly 204 by airgaps 207 and 207A. The magnetic field produced by one pole of the stator coil may return to the other pole by flux return path 208. The stator assembly may be supported by stator supports 209. Both the stator and rotor assemblies may be mounted inside a motor housing 210. The rotating shaft 206 may be located on the housing by two bearings 211 as shown in FIGS. 7 and 7A. A vacuum jacket 212 having an inner vessel and an outer vessel with extra insulation creates a structure within the housing 210. The stator assembly 204 and rotor assembly 205 may be mounted in side this structure. This structure may be defined as low temperature cryostat 213. The function of the cryostat 213 is to maintain superconducting temperatures for the stator coil 214 and rotor coils 215 to maintain superconducting properties to conduct superconducting currents and maintain flux. Both the stator coil 214 and rotor coils 215 are preferably wound with HTS 2G superconducting wires. This may allow motor operation at or below 77K.

A rotor power unit (RPU) 216 may be installed on the shaft 206. The RPU 216 may have a rotating member and a stationary member. The stationary member may be mounted on the housing 210 and the rotating member may be mounted on the shaft 206. DC or AC power may be applied to the stationary member of the RPU 216 and electrical power transferred to the rotating member electromagnetically. The output of the rotating member may be connected to the rotor coils 215. The rotor coils 215 may be connected in series or parallel to the output of the RPU 216 to obtain a desired result.

Since high air gap sheer stresses may be generated, this may result in high mechanical forces on the rotor coils 215. Therefore, it may be important to wind the rotor coils 215 in a high strength coil former made from high strength suitable material and impregnated with epoxy resins. The input to the rotor coils may be DC.

A closed loop cryogenic refrigeration system 217 as shown in FIGS. 7 and 7A may be located outside the motor housing and connected to the cryostat by refrigerant transfer tube 217A and return tube 217B as shown in FIGS. 7 and 7A. The cryogenic refrigeration system 217 conducts heat from the rotor coils 215 and the stator coils 214 to the cryogenic refrigeration system 217, where the heat is dissipated. Cryogenic refrigeration system 217 maintains superconducting temperatures inside the cryostat 213 by circulating cryogenic refrigerant at superconducting temperatures. This keeps the stator coil 214 and rotor coils 215 in the superconducting state.

The rotor coils 215 may be connected to the rotor shaft 206 by a torque tube 218 and the outer surface of the torque tube also forms the support structures for the rotor coils 215. The function of torque tube 218 is to transfer the torque produced by the rotor coils 215 to the shaft 206. The torque tube 218 also acts as a heat shield between the cryostat and the shaft 206 exposed to outside warm temperatures. This reduces the thermal load on cryogenic refrigeration system. The separate sections of the shaft 206 where coil is not mounted contains torque tube extensions 218A which also insulates cryostat from the sections of shaft 206 exposed to warm temperatures.

An electromagnetic shield 219 is fabricated around the stator assembly 214 and is attached to vacuum jacket 112. The stator assembly 214 is secured to the housing by stator supports 220. The function of the RPU 216 is to transfer power to the rotating member and the RPU 216 may be located either inside the cryostat 213 or outside the housing 210 on the shaft 206.

Under the description of operating principles for rotor coils 215 perpendicular to the stator coil 214 is described in detail how different electromagnetic mechanisms generate the required torque for the rotor coils 215.

For the motor operation to take place the rotor coils 215 may be connected to the stator coil 214 and the stator coil 214 may be powered from PSS and rotor coils 215 may be powered with RPU 216.

Operating Principles of Superconducting DC Motor with Multisided Rotor Coils Provided with Right Angle Extension

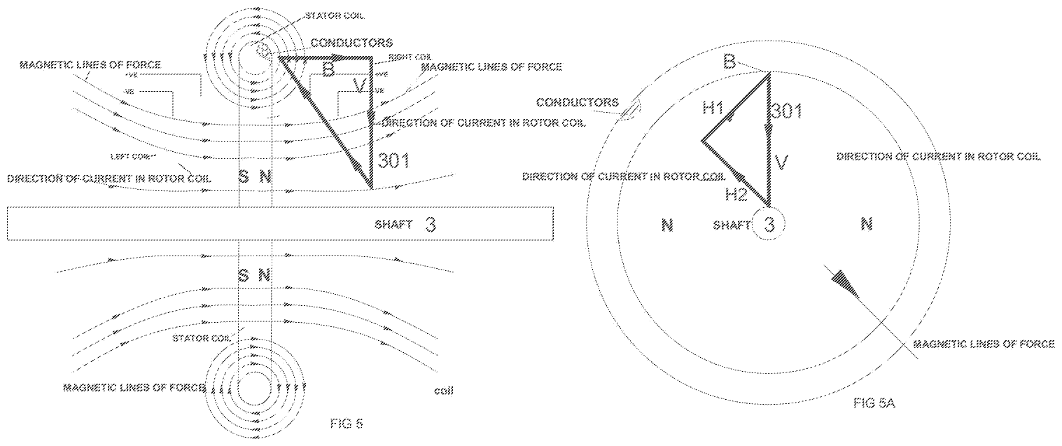

FIGS. 5 and 5A show the principle of motor action according to the present application. A stationary stator coil 2 may generate a magnetic field as shown in FIGS. 5 and 5A.

A rotating shaft 3 may be assembled as shown in FIGS. 5 and 5A. One coil 301 as shown in FIGS. 2B and 2C with sides B, V and a right-angled extension consisting of sections H1 and H2 which are bent at right angles to the plane of sides B and V may be mounted on the shaft as shown in FIGS. 5 and 5A. Only one coil is shown to demonstrate the novelty and strength of the present application. It is possible to operate the motor with only one coil to demonstrate the principle of operation, but in actual practice a large number of coils may be assembled to meet desired specification. These coils link the magnetic field generated by the stator coil 2.

When the rotor coil 301 described in FIGS. 2B and 2C is supplied with DC current and with the direction of current as shown in FIGS. 5 and 5A the following actions take place.

Applying Fleming's left-hand rule of the motor action to side B of the coil 301 which is parallel to the shaft 3 it will be observed that this action may cause the shaft to rotate when forces are generated on the coil sides B. In a similar manner side V of the coil 301 which is perpendicular to the shaft 3, it may be observed that this action causes the shaft to rotate when forces are generated on the coil side V. The coil sides B and V of coil 301 may tend to rotate the shaft depending on the direction of current in each coil side and the direction of the magnetic field which these sides link. The direction of torque produced by each coil side may be determined by the Fleming's left-hand rule of motor action and this action may produce final rotational effect on the rotation of the shaft 3.

Looking at the coil 301 from right to left towards the center of the shaft 3, the direction of current in the coil 301 may be shown in FIGS. 5 and 5A. Applying the Fleming's left-hand rule of motor action, the coil side B of the coil 301 may generate the rotation of the coil in anticlockwise direction and simultaneously the coil side V of coil 301 may generate the rotation of the coil in anticlockwise direction. These two rotational forces may be in the same direction and the net rotational force exerted on the shaft may be the sum of torque produced by sides B and V in anticlockwise direction.

In a similar manner, applying the Fleming's left-hand rule of motor action to the coil side extensions H1 and H2 of the multisided coil 302, it may be observed that the current flowing in right angle extensions H1 and H2 are in different directions to the current flowing in sides B and V. This may cause the torque produced by H1 and H2 in different direction to the torques produced by the sides B and V. The torques produced by the right-angled extension H1 and H2 may rotate the coil and not the shaft 3. The right-angled extension H1 may generate the rotation of the coil in direction which may be different than the direction of the torque produced by sides B and V. In a similar manner the right-angled extension H2 of multisided coil 302 may generate the rotation of the coil in the direction which may be different than the direction of the torque produced by sides B and V. These two rotational forces generated by H1 and H2 may be in different direction than rotational force produced by sides B and V and will not result in a net rotational force exerted on the shaft by H1 and H2. Because the torques produced by the right-angled extension H1 and H2 may rotate the coil and not the shaft 3, the force exerted by H1 and H2 on the shaft will be of negligible quantity. The final rotational force produced by the coil may be mainly the sum of rotational torques produced by coil sides B and V.

Selecting a flux density generated by stator coil 3 and the number of turns of stator and rotor coils and dimensions of the sides B, the motor may be able to produce desired values of torque, speed and power output of the motor. The fully cryogenic design of the motor and generator may eliminate rotor coupling for refrigerant and associated cost, reliability problems and maintenance involved.

It may be observed that power output and power density available with the present application is much higher than the prior art superconducting motors and generators. These design concepts and fully cryogenic refrigeration may produce more than double the power density and thus power output of a motor of similar size available in the prior art superconducting motors and generators.

Construction and Assembly of Superconducting DC Motor with Rotor Coils Provided with Right Angle Extension

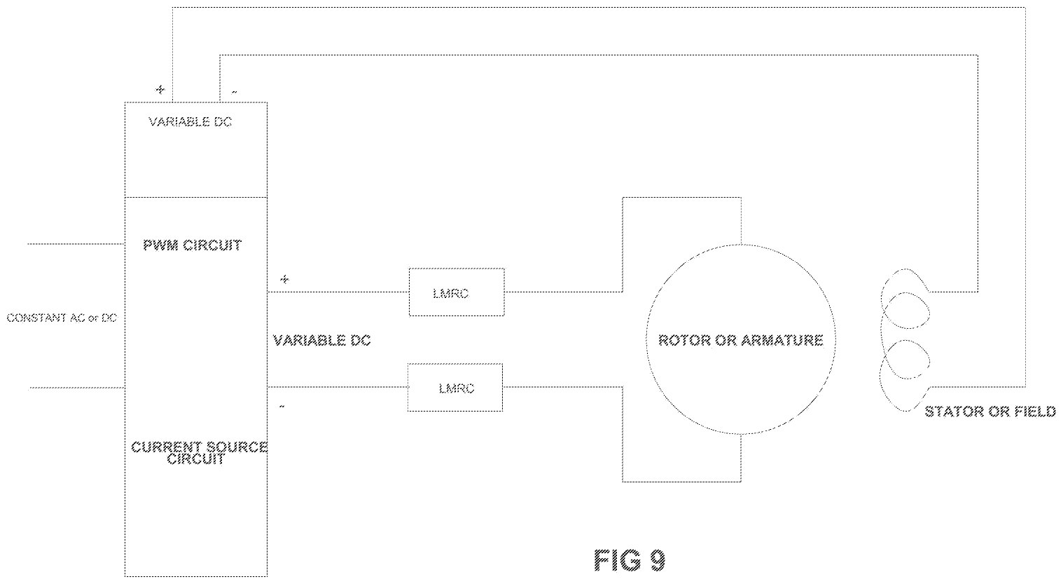

FIGS. 8 and 8A show the construction and integrated assembly of a superconducting motor with rotor coils with right angle extension.

The motor includes a stator assembly 304 and a rotor assembly 305. The rotor assembly 305 may be mounted on a rotating shaft 306 and the rotor assembly rotates as it magnetically links the stator assembly 304 by airgaps 307 and 307A. The magnetic field produced by one pole of the stator coil may be returned to the other pole by flux return path 308. The stator assembly 304 may be supported by stator supports 309. Both the stator assembly 304 and rotor assembly 305 may be mounted inside a motor housing 310.

The rotating shaft 306 may be located on the motor housing 310 by two bearings 311 as shown in FIGS. 8 and 8A. A vacuum jacket 312 having an inner vessel and an outer vessel with extra insulation creates a structure within the motor housing 310. The stator assembly 304 and rotor assembly 305 may be mounted inside this structure. This structure may be defined as low temperature cryostat 313. The function of the cryostat 313 is to maintain superconducting temperatures for the stator coil 314 and rotor coils 315 to maintain superconducting properties to conduct superconducting currents and maintain flux. The low temperature cryostat 313 makes use of the latest technology available for the design of cryostats. The vacuum jacket is designed to maintain selected vacuum properties for the life of the superconducting motor or a generator. For smaller rating motors and generators, the vacuum jacket is fabricated from stainless steel. However, for high power applications, the vacuum jacket is fabricated from a composite material such as a fiber reinforced epoxy. either by filament winding or by manually. In one embodiment, the inner and outer vessels of the vacuum jacket are fabricated of a non-magnetic composite material.

The technology for materials used in electrical machines has advanced to a great extent and several different types of material available for design of various components of the motor has increased. The stator housing 310 can be made from black iron, steel, aluminum alloys or for larger machines titanium alloys.

Both the stator coil 314 and rotor coils 315 are preferably wound with HTS 2G superconducting wires. This may allow motor operation at or below 77K.

A rotor power unit (RPU) 316 may be installed on the shaft 206. The RPU 316 has a rotating member and a stationary member. The stationary member may be mounted on the motor housing 310 and the rotating member may be mounted on the shaft 306. DC or AC power may be applied to the stationary member of the RPU 316 and electrical power transferred to the rotating member electromagnetically. The output of the rotating member may be connected to the rotor coils 315. The rotor coils 315 may be connected in series or parallel to the output of the RPU 316 to obtain a desired result.

Since high air gap sheer stresses may be generated this may result in high mechanical forces on the rotor coils 315. Therefore, it may be important to wind the rotor coils 315 in a high strength coil former made from high strength suitable material and impregnated with epoxy resins. The input to the rotor coils may be DC.

A closed loop Cryogenic refrigeration system 317 as shown in FIGS. 8 and 8A may be located outside the motor housing 310 and connected to the cryostat by refrigerant transfer tube 317A and return tube 317B as shown in FIGS. 8 and 8A. The cryogenic refrigeration system 317 conducts heat from the rotor coils 315 and the stator coil 314 to the cryogenic refrigeration system 117, where the heat is dissipated. Cryogenic refrigeration system 317 maintains superconducting temperatures inside the cryostat 313 by circulating cryogenic refrigerant at superconducting temperatures. This keeps the stator coil 314 and rotor coils 315 in the superconducting state.

The rotor coils 315 are connected to the rotor shaft 306 by means of torque tube 318 and the outer surface of the torque tube also forms the support structures for the rotor coils 315. The function of torque tube 318 is to transfer the torque produced by the rotor coils 315 to the shaft 306. The torque tube 318 also acts as a heat shield between the cryostat and the shaft 306 exposed to outside warm temperatures. This reduces the thermal load on cryogenic refrigeration system. The separate sections of the shaft 306 where coil is not mounted contains torque tube extensions 318A which also insulates cryostat from the sections of shaft 106 exposed to warm temperatures.

Torque tube 318 is a very important component of the machine and can be fabricated from Inconel or any other suitable material with high mechanical strength and low thermal conductivity to prevent heat transfer to cryogenic components.

An electromagnetic shield 319 is fabricated around the stator assembly 314 and is attached to vacuum jacket 312. The stator assembly 304 is secured to the housing by stator supports 320.

Under the description of operating principles for rotor coils 315 right angled extension 314 is described in detail how different electromagnetic mechanisms generate the required torque for the rotor coils 315.

Operating Principles of Superconducting DC Motor with the Plane of Rotor Coils Perpendicular to the Stator Coil

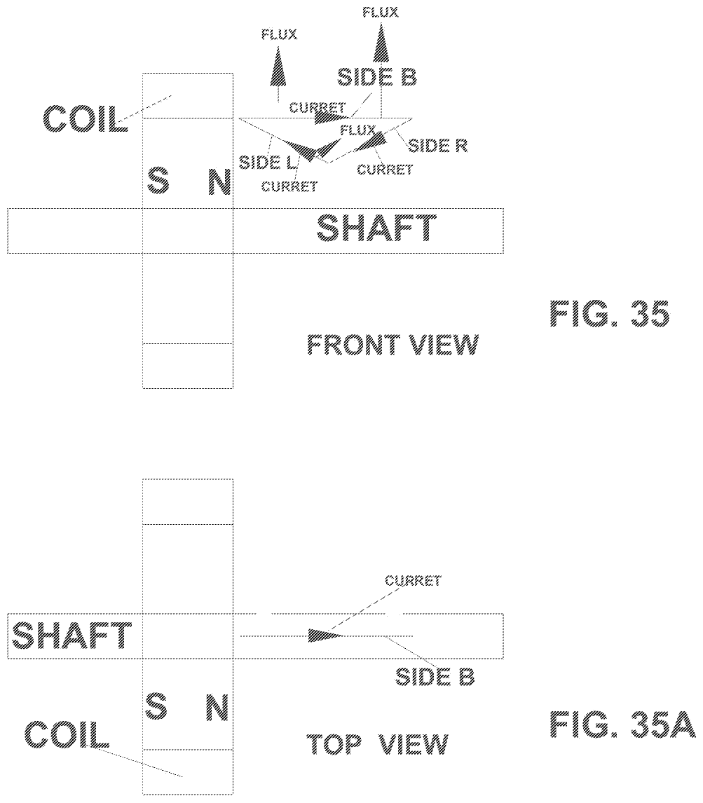

FIGS. 35 and 35A show the principle of motor action according to the present application where rotor coils can be used in two configurations. For the motor action the term stator and field and rotor and armature are used interchangeably. A stationary stator will include a stator coil and will generate magnetic field as shown in FIGS. 35 and 35A.

A rotating shaft is assembled as shown in FIGS. 35 and 35A. At least one coil as shown in FIGS. 35 and 35A with sides L, R and B are mounted on the shaft. In this embodiment the plane of the coil is perpendicular to the shaft. Only one coil is shown to describe the principle of operation but in actual practice a large number of coils may be assembled to meet desired specifications. This coil links the magnetic field generated by stator coil as shown in FIGS. 35 and 35A. The flux produced by the north pole of stator coil will be vertical near the circumference of the stator coil.

When the rotor coil is supplied with DC current and with the direction of current as shown in FIGS. 35 and 35A, the following actions takes place.

Applying Fleming's left-hand rule of the motor action to Side B of the rotor coil which is parallel to the shaft it will be observed that this action will cause the shaft to rotate when forces are generated on the coil side B. The coil sides L and R of the rotor will tend to rotate the shaft depending on the direction of current in each coil side and the direction of the magnetic field which these sides link. The direction of torque produced by each coil side will be determined by the Fleming's left-hand rule of motor action and this action will produce final rotational effect on the rotation of the shaft 703.

Looking at the rotor coil from right to left of this page towards the center of the shaft the direction of the current in the rotor coil will be as shown in FIGS. 35 and 35A. Applying the Fleming's left-hand rule of motor action, the current in coil side B will be from left to right and direction of magnetic flux from the north pole of stator coil will be in vertical direction. This interaction will generate the rotation of the coil in anticlockwise direction and simultaneously applying the Applying the Fleming's left-hand rule of motor action to the coil side R of the rotor coil, the coil side R, depending on the direction of the flux interacting with the coil side R also generate the rotation of the coil in the antilock wise direction. In a similar manner Applying the Fleming's left-hand rule of motor action to the coil side L of the rotor coil, the flux from north pole of stator coil will be interacting in the same direction. But the current will be in the opposite direction to that of coil side R This will generate the rotation of the coil in clockwise direction.

It will be observed that the rotational torque produced by coil sides B, R of the coil will in the same direction depending on the direction of the flux interacting with the coil side R but the torque produced by coil side L will be in the opposite direction and the torque produced by sides L and R will cancel out each other and resultant torque produced by rotor coil will be the sum of torque produced by the coil sides B and R minus the torque produced by side L.

In a similar manner an embodiment can be designed with the plane of the coil parallel to the shaft the plane of the coil rotating circumferentially along the stator coil. Again, applying the Flemings left hand rule of motor action, to all the sides of the coil, the motor will produce rotation and torque in the desired direction.

Operating Principles of Superconducting DC Motor with Rotor Coils Perpendicular to the Two Opposing Stator Coils of Like Polarity

FIGS. 33 and 33A show the principle of motor action according to the present application where two stator coils are used. For the motor action the term stator and field and rotor and armature are used interchangeably. A stationary stator will include two stator coils of like polarity opposing each other and will generate magnetic field as shown in FIGS. 33 and 33A. The resultant field created by the 2 coils of like polarity is well understood in prior art and can be found in any literature on magnetic fields.

A rotating shaft 703 is assembled as shown in FIGS. 33 and 33A. At least one coil 701 as shown in FIGS. 33 and 33A with sides A, B, and C are mounted on the shaft. Only one coil is shown to describe the principle of operation but in actual practice a large number of coils may be assembled to meet desired specifications. This coil links the magnetic field generated by two stator coils S1 and S2 of like polarity as shown in FIGS. 33 and 33A. The flux produced by the north pole of coil S1 will interact with the flux produced by the north pole of coil S2. There will be a zone of zero magnetic fields between the two coils and the direction of the lines of magnetic field from coils S1 and S2 will be vertical near the circumference of the two coils.

When the rotor coil 701 is supplied with DC current and with the direction of current as shown in FIGS. 33 and 33A, the following actions takes place.

Applying Fleming's left-hand rule of the motor action to Side A of the rotor coil 701 which is perpendicular to the shaft 703 it will be observed that this action will cause the shaft to rotate when forces are generated on the coil side A. The coil sides B and C of coils 701 and will tend to rotate the shaft depending on the direction of current in each coil side and the direction of the magnetic field which these sides link. The direction of torque produced by each coil side will be determined by the Fleming's left-hand rule of motor action and this action will produce final rotational effect on the rotation of the shaft 703.

Looking at the coils 701 from right to left of this page towards the center of the shaft 703 the direction of the current in the coil 701 will be as shown in FIGS. 33 and 33A. Applying the Fleming's left-hand rule of motor action, the current in coil side A will be from top to bottom and direction of magnetic flux from the north pole of stator coil S1 will be from left to right of the coil 701. This interaction will generate the rotation of the coil in anticlockwise direction and simultaneously applying the Applying the Fleming's left-hand rule of motor action to the coil side C of the coil 701, coil side C will also generate the rotation of the coil in the antilock wise direction. These two rotational forces will be in the same direction and the net rotational force exerted on the shaft will be the addition of the force generated by the sides A and C.

In a similar manner Applying the Fleming's left-hand rule of motor action to the coil side B of the coil 701, the flux from both north poles of stator coils S1 and S2 will be interacting in the same direction. This will also generate the rotation of the coil in anticlockwise direction.

It will be observed that the rotational torque produced by coil sides A, B and C of the coil 701 will in the same direction and the resultant torque produced by coil 701 will be the sum of torque produced by the coil sides A, B and C of coil 701.

It will be observed that in the embodiment of the superconducting motor with two stator coils, the torque produced by the motor will be contributed by all the coil sides of the rotor coils. This will offer higher power density for the rotor. This will result in lower rotor inertia and applications where lower rotor inertia and higher power density is desired this motor will offer an attractive solution.

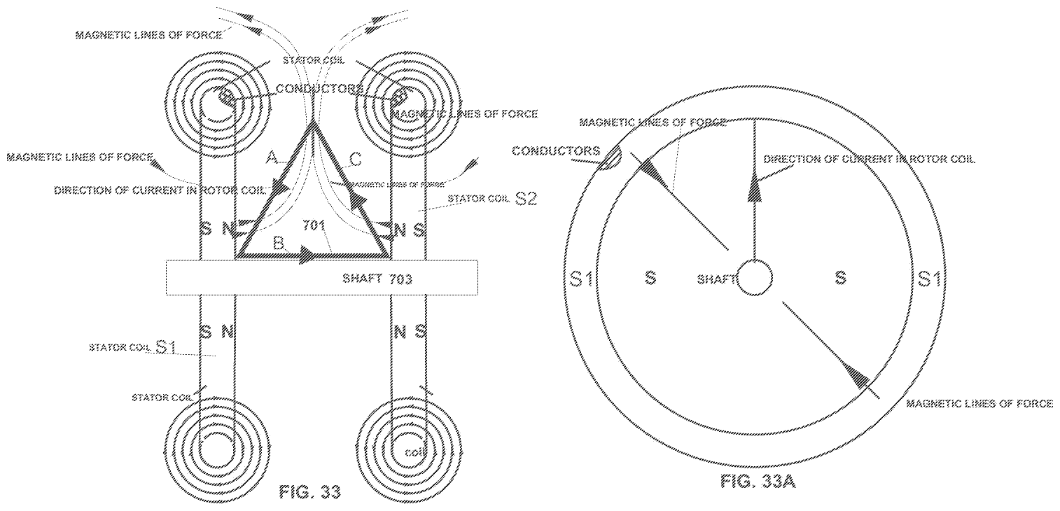

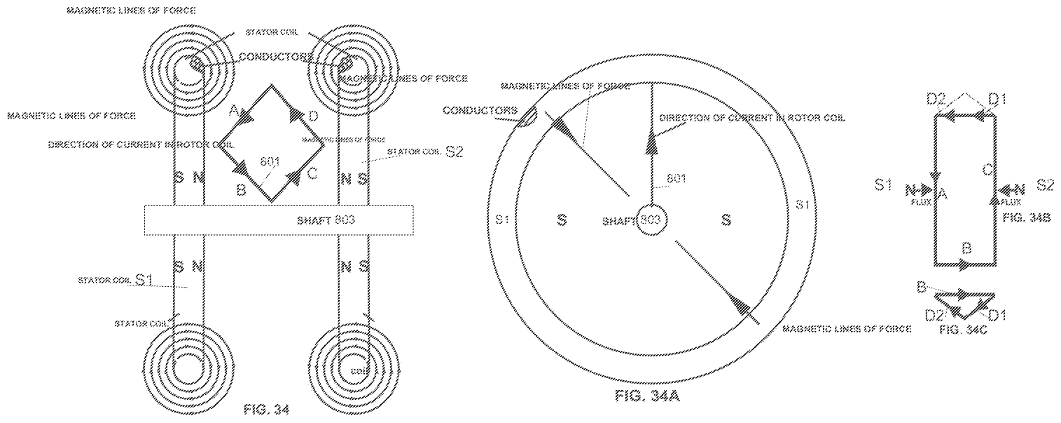

FIGS. 34 and 34A shows the principle of motor action according to the present invention where two stator coils are used. For the motor action the term stator and field and rotor and armature are used interchangeably. A stationary stator will include two stator coils of like polarity opposing each other and will generate magnetic field as shown in FIGS. 34 and 34A. The resultant field created by the 2 coils of like polarity is well understood in prior art and can be found in any literature on magnetic fields.

A rotating shaft 803 is assembled as shown in FIGS. 34 and 34A. At least one coil 801 as shown in FIGS. 34 and 34A with sides A, B, C and D are mounted on the shaft. Only one coil is shown to describe the principle of operation but in actual practice a large number of coils may be assembled to meet desired specifications. This coil links the magnetic field generated by two stator coils S1 and S2 of like polarity as shown in FIGS. 34 and 34A. The flux produced by the north pole of coil S1 will interact with the flux produced by the north pole of coil S2. There will be a zone of zero magnetic fields between the two coils and the direction of the lines of magnetic field from Coils S1 and S2 will be vertical near the circumference of the two coils.

In this embodiment the coil has 4 sides as shown in FIGS. 34 and 34A. The sides A and B link the flux produced by stator coil S1 and the coil sides C and D link the flux produced by stator coil S2 as shown.

When the rotor coil 801 is supplied with DC current and with the direction of current as shown in FIGS. 34 and 34A, the following actions takes place.

Applying Fleming's left-hand rule of the motor action to Sides A and B of the rotor coil 801 which is perpendicular to the shaft 803 it will be observed that this action will cause the shaft to rotate when forces are generated on the coil sides A and B. The coil sides C and D of coils 801 and will tend to rotate the shaft depending on the direction of current in each coil side and the direction of the magnetic field which these sides link. The direction of torque produced by each coil side will be determined by the Fleming's left-hand rule of motor action and this action will produce final rotational effect on the rotation of the shaft 803.

Looking at the coils 801 from right to left of this page towards the center of the shaft 803 the direction of the current in the coil 801 will be as shown in FIGS. 34 and 34A. Applying the Fleming's left-hand rule of motor action, the current in coil sides A and B will be from top to bottom and direction of magnetic flux from the north pole of stator coil S1 will be from left to right of the coil 801. This interaction will generate the rotation of the coil in anticlockwise direction and simultaneously applying the Applying the Fleming's left-hand rule of motor action to the coil sides C and D of the coil 801, coil sides C and D will also generate the rotation of the coil in the antilock wise direction. These two rotational forces will be in the same direction and the net rotational force exerted on the shaft will be the addition of the force generated by the sides A, B, C and D.

It will be observed that the rotational torque produced by coil sides A, B, C and D of the coil 801 will in the same direction and the resultant torque produced by coil 801 will be the sum of torque produced by the coil sides A, B, C and D of coil 801.

It will be observed that in the embodiment of the superconducting motor with two stator coils, the torque produced by the motor will be contributed by all the coil sides of the rotor coils. This will offer higher power density for the rotor. This will result in lower rotor inertia and applications where lower rotor inertia and higher power density is desired this motor will offer an attractive solution.

Operating Principles of Superconducting DC Motor with Rotor Coils with 5 Coil Sides

FIGS. 34B and 34C shows the principle of motor action by a coil with 5 sides with two parallel sides interacting with the two north poles of like polarity as shown in FIGS. 34B and 34C and magnetic interaction described earlier in embodiments with two stator coils.

The dotted line as shown in FIG. 34B demonstrates how the coil is originally wound with five sides. The sides D1 and D2 are then bent at right angles to sides A and C.

In the motor action the sides A and C as shown in FIGS. 34B and 34C will interact with two north poles of S1 and S2 and will produce the torque in the same direction. Similarly, the side B will also produce the torque in the same direction as sides A and C. The coil sides D1 and D2 will however produce torque in opposite direction and as explained earlier the force that produces the torque can be resolved along the X-axis and the Y-axis. The components of the force generated on D1 and D2 along the X-axis will be parallel to the shaft and the components of the force on D1 and D2 along the Y-axis will be perpendicular to the shaft. It will be observed that components of the force generated by D1 and D2 along the X-axis will be in opposite direction and will cancel each other. The components of force along the Y-axis will be in opposite direction to the torque produced by coil sides A, B and C. This will allow the coil sides A, B and C to produce the torque in the same direction. And the final rotational force exerted on the shaft which is the resultant torque produced by the coil will be the difference of torque produced by the coil sides A, B and C of the coil and the components of force along the Y-axis produced by coil sides D1 and D2.

Construction and Assembly of Superconducting DC Motor with Rotor Coils Perpendicular to the Stator Coils with Two Opposing Stator Coils of Like Polarity

FIGS. 6 and 6A, describe construction and assembly of superconducting motors with rotor coils perpendicular to the stator coil. FIGS. 7 and 7A, describe construction and assembly of superconducting motors with rotor coils parallel to the stator coil. and FIGS. 8 and 8A describe construction and assembly of superconducting motors with rotor coils with right angled extension. In the embodiments of the superconducting motor with two opposing stator coils of like polarity the construction and assembly of the motor will be identical the motor assembly described in FIGS. 6 and 6A, FIGS. 7 and 7A and FIGS. 8 and 8A. The difference in the final construction and assembly will be the stator assembly will have integrated assembly with two stator coils replacing one stator coil. The rotor coils will be located between the two stator coils.

The cryogenic cooling system for the DC superconducting motor with two opposing coils of like polarity will be similar to cryogenic cooling assemblies described in and construction and assembly of motor described in FIGS. 6 and 6A, FIGS. 7 and 7A and FIGS. 8 and 8A. The electrical power transfer scheme to transfer electrical power the rotor also will be identical.

Generator Action with Two Opposing Stator Coils of Like Polarity

FIGS. 33, 33A, 34, 34A, 34B and 34C describes the embodiments of a motor with two opposing stator coils with poles of like polarity interacting with rotor coils.

The principles of motor action can also be applied to generator action by reversing the function of the stator and rotor. Coils described in FIGS. 33 and 33A can be operated as stationary armature of generator by assembling them on stationary armature and rotating the two coils of opposing polarity linking this coil. Also Coils described in FIGS. 34 and 34A can be operated as stationary armature of generator by assembling them on stationary armature and rotating the two coils of opposing polarity linking this coil.

In the generator action the field coils may be rotating and the field excitation power may be supplied with proper exciter action as described earlier. The output power may be produced by the stationary armature coils.

### Connection Schemes for Stator and Rotor for Operation of Superconducting DC Motor

The present application offers performance characteristics and cost and size advantage not available in prior art electrical machines. Constant torque and smooth speed control are two of the main advantages. The electrical connection between the armature and field will be presented to achieve maximum benefits of the new concept.

There are 5 main connection schemes for the operation of DC motor in different operational modes. The selected DC motor stator (field) and rotor (armature) connections determine which operational mode the DC motor will operate in. DC power has to be applied to both stator and rotor coils by one of the four connections schemes.
Separately excited DC motor
Shunt DC motor
Series DC motor
Compound DC motor
AC transformer-controlled DC motor.

FIGS. 9 through 17 further describes 5 primary connection configurations by which rotor coils are connected to stator coil. The rotor power unit (RPU) supplies power to the rotor coils from a stationary source s without any physical connection or contacts that are subject to wear and tear between the stationary source and the rotor coils. It includes a stationary member and a rotating member. This arrangement makes it possible to implement a brushless commutatorless design configuration. Since there is no physical connection between the stationary and the rotating member of the RPU therefore no wear and tear occurs during the power transfer and ongoing maintenance is not required.

The rotor power unit (RPU) is used in 6 different design configurations.

Liquid metal rotating contacts (LMRC): In this connection method the stationary and rotating members of the rotor power unit (RPU) consists of liquid metal contacts and the stationary and rotating members are connected by liquid metal. In this method the DC power is applied directly to the rotor since the connection is made directly with the rotor coils through the liquid metal.

Conventional rotatable transformer: In this connection method the power is transferred through the airgap where the stationary member is the primary and the rotating member is the secondary of the rotatable transformer. Power is supplied to the primary and the rotor coils are connected to the secondary using proper rectifier and filter scheme for the DC power.

Superconducting rotatable transformer: In this method of connection the power is transferred through the airgap where the primary of the superconducting rotatable transformer is the stationary member and is provided with superconducting winding while the secondary of the rotatable transformer is the rotating member and is connected to the rotor coils and provided with superconducting winding. Power is supplied to the primary and the rotor coils are connected to the secondary using proper rectifier and filter scheme for the DC power.

Conventional switch mode rotatable transformer: The technology relating PWM (pulse width modulation) power supply is very advanced and widely used to provide DC power to a variety of electrical and electronic equipment. The technology to design and build PWM power supply is readily available in the industry. With the availability of low cost PWM systems it is possible to develop cost effective power supply architectures for the brushless transfer of power to the rotor of the motor according to the requirement of each motor. In a rotatable switch mode power transformer, the power is transferred through the airgap from the stationary primary winding to the rotating secondary winding where rotor coils are located. The stationary member which is the primary is provided with switched DC power and the rotating member which is the secondary of the switch mode rotatable transformer is provided with rectifier and filter circuit to provide necessary DC power to the rotor coils. It is also possible to step up or down the voltage and current when needed. Power is supplied to the primary and the rotor coils are connected to the secondary to provide necessary torque to the shaft.

Superconducting switch mode rotatable transformer: The technology relating PWM (pulse width modulation) power supply is very advanced and widely used to provide DC power to a variety of electrical and electronic equipment. Technology to design and build PWM power supply is readily available in the industry. With the availability of low cost PWM systems it is possible to develop cost effective power supply scheme for the brushless transfer of power to the rotor of the motor according to the requirement of each motor. In a superconducting rotatable switch mode power transformer, the power is transferred through the airgap from the superconducting stationary primary winding to the rotating superconducting secondary winding where rotor coils are located. The stationary member which is the superconducting primary is provided with switched DC power and the rotating member which is the superconducting secondary of the switch mode rotatable transformer is provided with rectifier and filter circuit to provide necessary DC power to the rotor coils. Power is supplied to the primary and the rotor coils are connected to the secondary to provide necessary torque to the shaft.

Long life slipring assembly: the technology of slipring assemblies for electrical devices and machines has developed to a state where very reliable and inexpensive sliprings with long operational life is readily available. With the availability of these advanced sliprings, it is possible to use them in applications where low-cost brushless operation is required. The sliprings can be readily adapted to PWM power operation. Sliprings can be used in place of LMRC for low-cost applications and where sliprings offer compact and simple solution.

DC motors have been employed in large number of different applications in most industries for more than a century. Because of the vast experience gained during the time in design methodologies and manufacturing methods, the DC motors can be effectively designed and manufactured for any desired application. This knowledge can be applied to the present invention. The novel and innovative difference is that brushes and commutators are eliminated.

POWER SUPPLY SUBSYSTEM: The function of the power supply subsystem (PSS) is to supply DC power to the armature and field winding of the DC motor. In applications where conventional or superconducting transformers are used, the PSS provides AC power as needed.

PWM method of voltage control is very efficient and cost-effective way to generate DC power compared to other methods currently used for the control of superconducting motors. PWM method is very effective for the control of DC motor according to the present invention. It can also generate variable AC if needed.

Variable DC is generated by a dedicated PWM circuit for the application of DC voltage to the armature and this voltage is supplied to the armature by one of the 6 methods described earlier.

Variable DC is also generated by a second dedicated field control PWM circuit for the application of DC voltage to the field circuit and this voltage is supplied to the field circuit by one of the 6 methods described earlier.

A current source circuit is also provided on the PSS. Current source limits the maximum current that can be supplied to the motor. When coils reach superconducting state the resistance of the coil becomes zero. And when voltage is applied to the coil in the superconducting state a large current will flow and if this current exceeds the critical current for the superconducting wires of the coils a catastrophic failure termed quenching comes into existence. This is effectively controlled by the current source circuit.

When operated as DC motor the operational characteristics of the motor are determined by the connection between the stator coils and the rotor coils. FIGS. 9 to 17 shows different connection schemes for DC motor to obtain different operational characteristics.

As stated earlier there are six main connection schemes for operation of DC motor in different modes. We will now describe each connection scheme in detail. Another important requirement to be considered is the availability of current source power for the superconducting motors. Current source limits the maximum current that can be supplied to the motor. When coils reach superconducting state the resistance of the coil becomes zero. And when voltage is applied to the coil in the superconducting state a large current will flow and if this current exceeds the critical current for the superconducting wires of the coils a catastrophic failure termed quenching comes into existence.

SEPARATELY EXCITED DC MOTOR: The stator and rotor coils of the motor are supplied with DC power separately. DC power can be connected directly to the stator coil and DC power can be supplied to the rotor coils by means of one of the six methods described earlier. Speed control of the motor is achieved by controlling the voltage to stator or rotor.

FIG. 9 shows the connection scheme for separately excited motor using Liquid metal rotating contacts (LMRC). The same scheme can be applied to sliprings when used. Separate source of DC power is used for rotor (armature) and stator (field) connection. As shown the power supply subsystem provides DC power with variable voltage to the armature by LMRC and the field is separately supplied with independent variable DC voltage directly from the power supply subsystem. When LMRC is used the rectification and filtering for the armature PWM circuit is done on the PSS and only distortion free DC is applied to the armature. The rectification and filtering for the field circuit is also performed on the PSS. The DC motor speed is controlled by independently controlling the voltage applied to the armature and to the field winding of the motor.

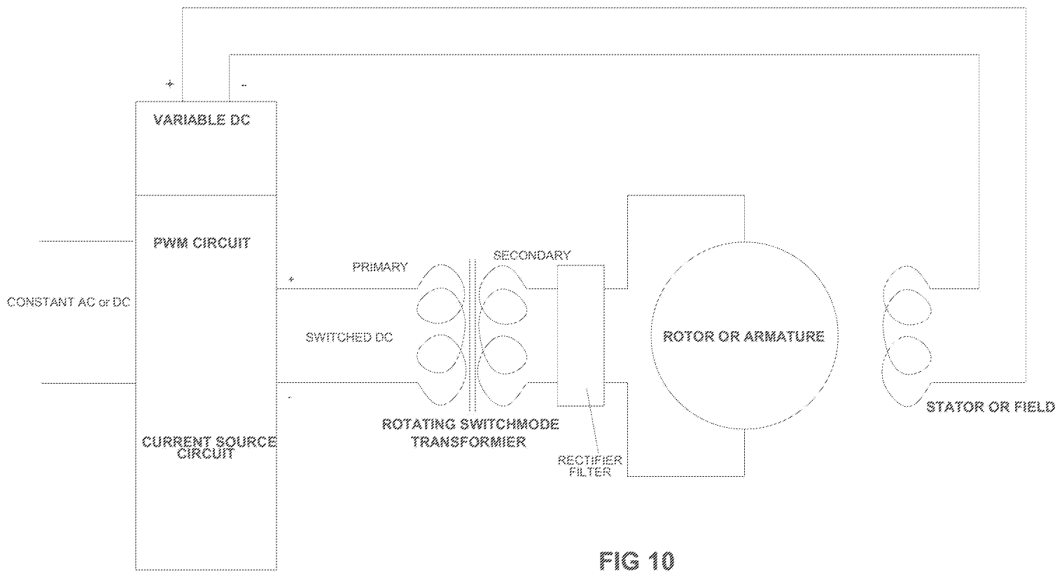

FIG. 10 shows the connection scheme for separately excited motor using rotatable switch mode transformer (RSMT). The same scheme can be applied to sliprings when used. Separate source of DC power is used for rotor (armature) and stator (field) connection. When RSMT is used for supplying the power to the armature, switched DC is provided to the primary of the RSMT and the secondary located on the rotating shaft is provided with the rectification and filtering circuit to supply distortion free DC to the armature. As shown the power supply subsystem provides DC power with variable voltage to the armature by rotatable switch mode transformer (RSMT). And the field is separately supplied with independent variable DC voltage directly supplied by the power supply subsystem. The DC motor speed is controlled by independently controlling the voltage applied to the armature and to the field winding of the motor.

PERFORMANCE CHARACTERISTICS: When constant current is maintained in the armature by PSS and variable voltage is supplied to the field circuit a smooth speed control of the motor is achieved.

It is also possible to control and achieve speed control by simultaneously varying both armature and field voltage. This method will allow the motor to operate in different torque and speed characteristics.

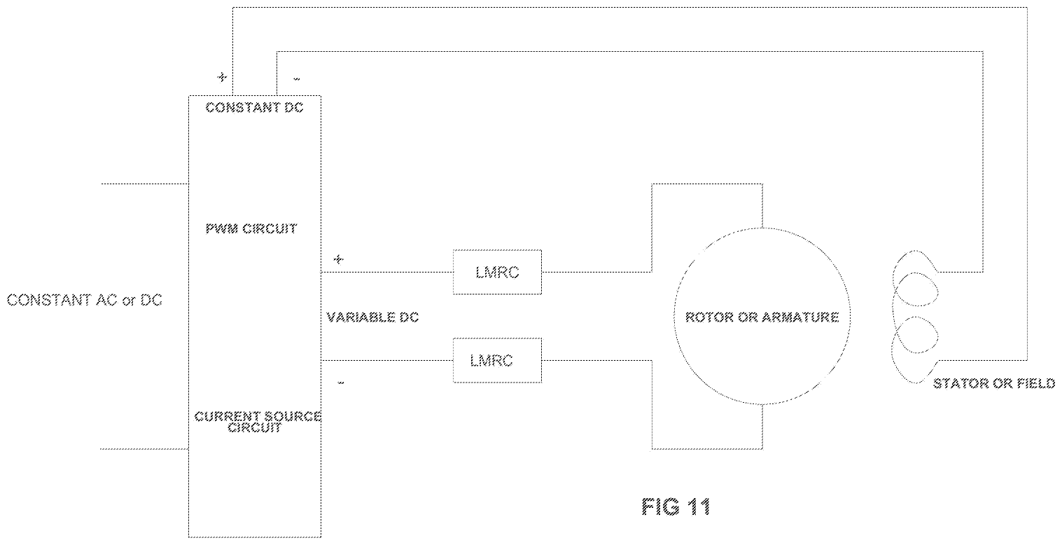

DC SHUNT MTOR: DC shunt motor is one of the most widely used DC motor FIG. 11 shows the connection scheme for a DC shunt motor utilizing liquid metal rotating contact (LMRC). The rotor and stator are connected in parallel. The same scheme can be applied to sliprings when used. Separate source of DC power is used for rotor (armature) and stator (field) connections. As shown the power supply subsystem provides DC power with variable voltage to the armature by LMRC and the field is separately supplied with independent variable DC voltage directly from the power supply subsystem shows the connection scheme for DC shunt motor using. The rectification and filtering for the field circuit is also performed on the PSS. The DC motor speed is controlled by independently controlling the voltage applied to the armature and to the field winding of the motor.

Most widely used speed control method for DC shunt motor is maintaining constant voltage to the field circuit and supplying variable voltage to the armature.

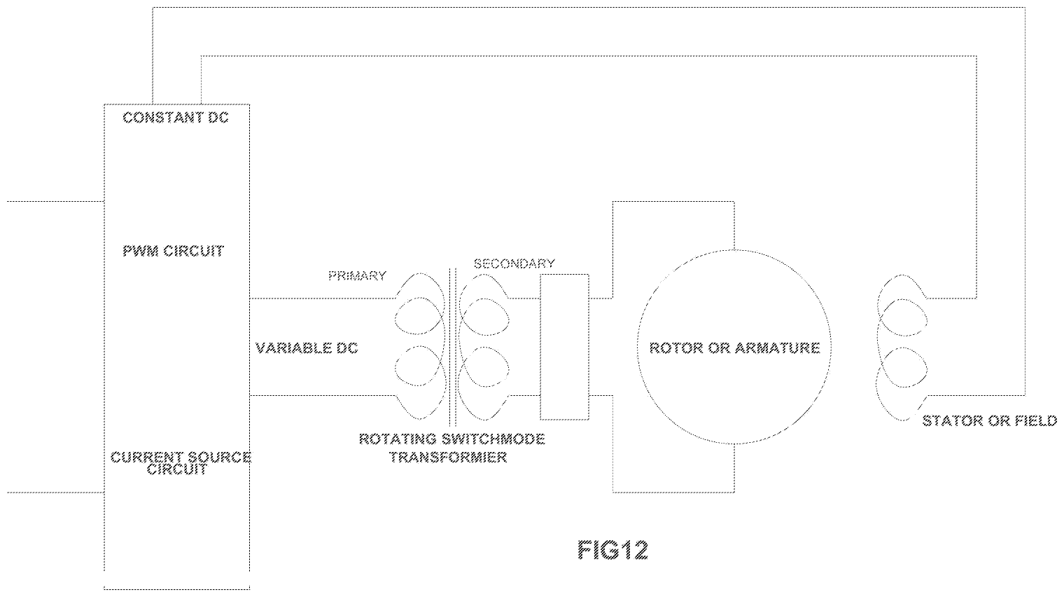

FIG. 12 shows the connection scheme for DC shunt motor using rotatable switch mode transformer (RSMT). Separate source of DC power is used for rotor (armature) and stator (field) connection. When RSMT is used for supplying the power to the armature, switched DC is provided to the primary of the RSMT and the secondary located on the rotating shaft is provided with the rectification and filtering circuit to supply distortion free DC to the armature. As shown the power supply subsystem provides DC power with variable voltage to the armature by rotatable switch mode transformer (RSMT). And the field is separately supplied with independent variable DC voltage directly supplied by the power supply subsystem. The DC motor speed is controlled by independently controlling the voltage applied to the armature and to the field winding of the motor.

Most widely used speed control method for DC shunt motor is maintaining constant voltage to the field circuit and supplying variable voltage to the armature.

PERFORMANCE CHARACTERISTICS: When constant voltage is maintained to the field circuit and variable voltage is supplied to the armature by PSS, a smooth speed control of the motor is achieved. The motor also maintains constant torque over wide speed range. Both speed and acceleration can be accurately controlled by this method. DC shunt motor has excellent speed regulation at different load conditions.

It is also possible to control and achieve speed control by simultaneously varying both armature and field voltage. This method will allow the motor to operate in different torque and speed characteristics.

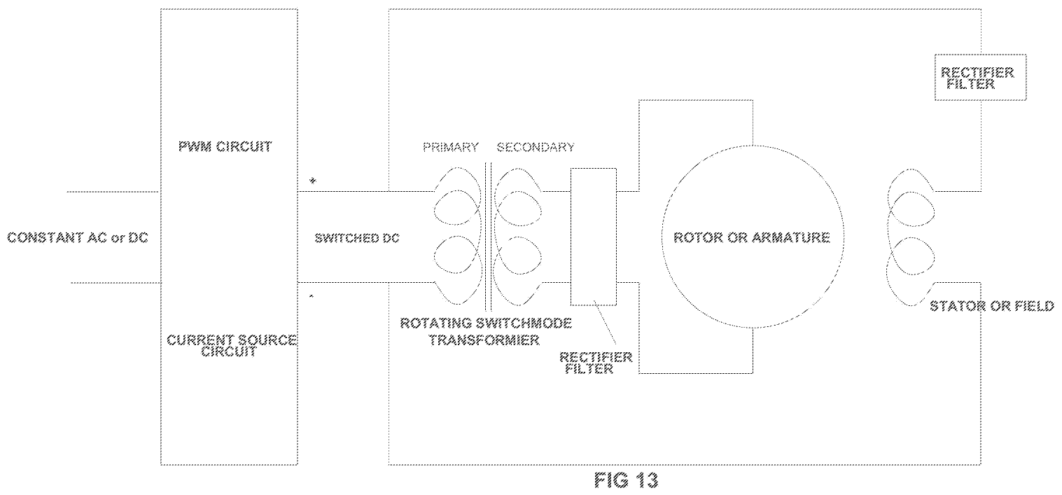

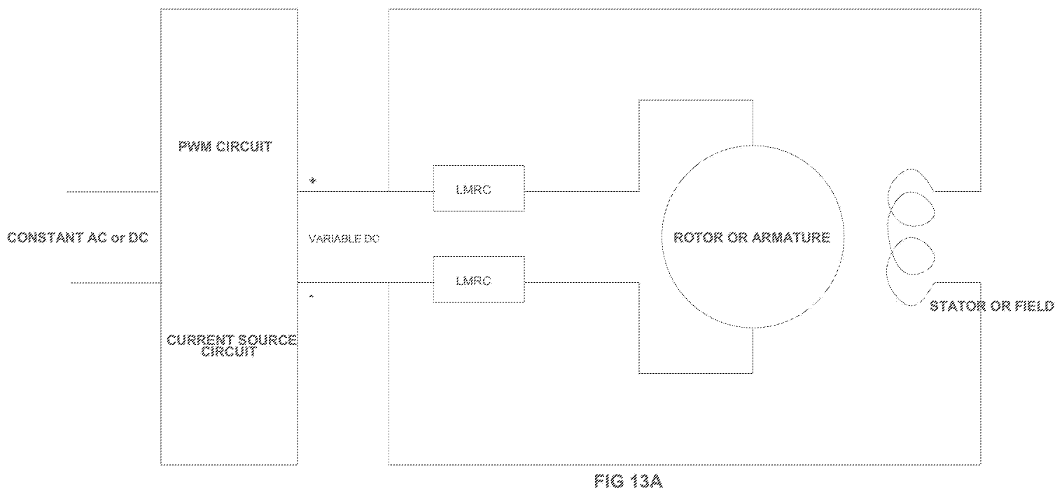

DC MOTOR WITH VARIABLE VOLTAGE OPERATION: FIG. 13 shows the connection scheme for DC shunt motor using rotatable switch mode transformer (RSMT) where both the armature and the shunt field are provided with variable DC power. Same source of variable DC power is used for rotor (armature) and stator (field) connection. When RSMT is used for supplying the power to the armature, switched DC is provided to the primary of the RSMT and the secondary located on the rotating shaft is provided with the rectification and filtering circuit to supply distortion free DC to the armature. The field is also provided with the rectification and filtering circuit. As shown the power supply subsystem provides DC power with variable voltage to the armature and field by rotatable switch mode transformer (RSMT).

FIG. 13A shows the connection scheme for DC shunt motor using LMRC. The rectification and filtering for the field circuit is performed on the PSS. Desired variable voltage is applied to both the armature and the field winding through LMRC.

PERFORMANCE CHARACTERISTICS: When constant voltage is maintained to the field circuit and variable voltage is supplied to the armature by PSS, a smooth speed control of the motor is achieved. Both speed and acceleration can be accurately controlled by this method.

It is also possible to control and achieve speed control by simultaneously varying both armature and field voltage.

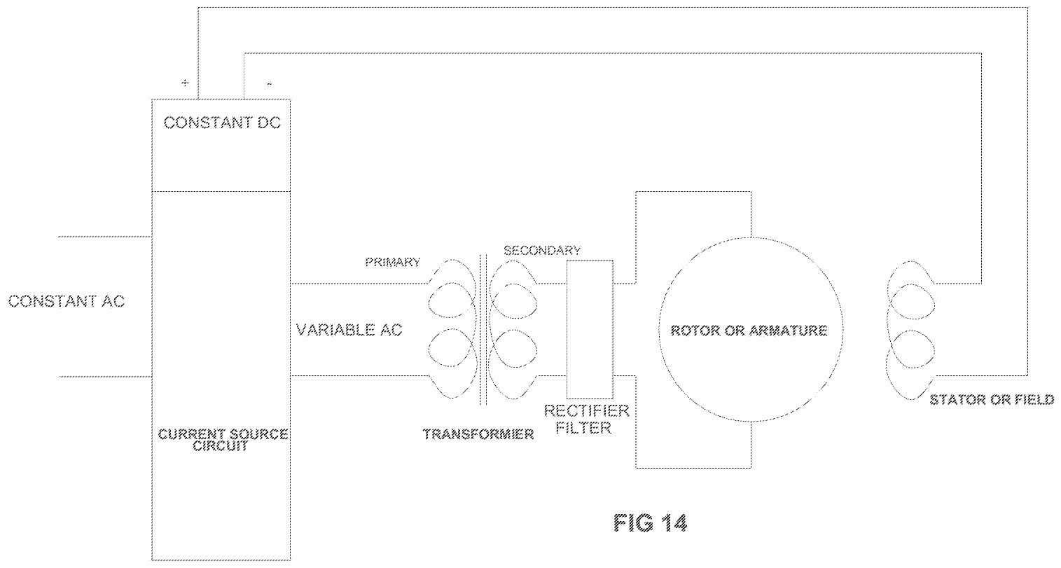

AC TRANSFORMER CONTROLLED DC MOTOR: FIG. 14 shows the connection scheme for DC shunt motor using AC transformer. The AC transformer can be of conventional design or superconducting design. The same scheme can be applied to sliprings when used. Separate source of DC power is used for rotor (armature) and stator (field) connection. When AC transformer is used for supplying the power to the armature, variable AC is provided to the primary of the AC transformer and the secondary located on the rotating shaft is provided with the rectification and filtering circuit to supply distortion free DC to the armature. As shown the power supply subsystem provides variable AC voltage to the armature by AC transformer. And the field is separately supplied with independent variable DC voltage directly supplied by the power supply subsystem. The AC transformer scheme is not as efficient as the PWM speed control. The DC motor speed is controlled by independently controlling the voltage applied to the armature and to the field winding of the motor. FIG. 14 shows the AC transformer employed to control a DC shunt motor. It is also possible to employ other methods to control the speed of DC motor using AC transformer.

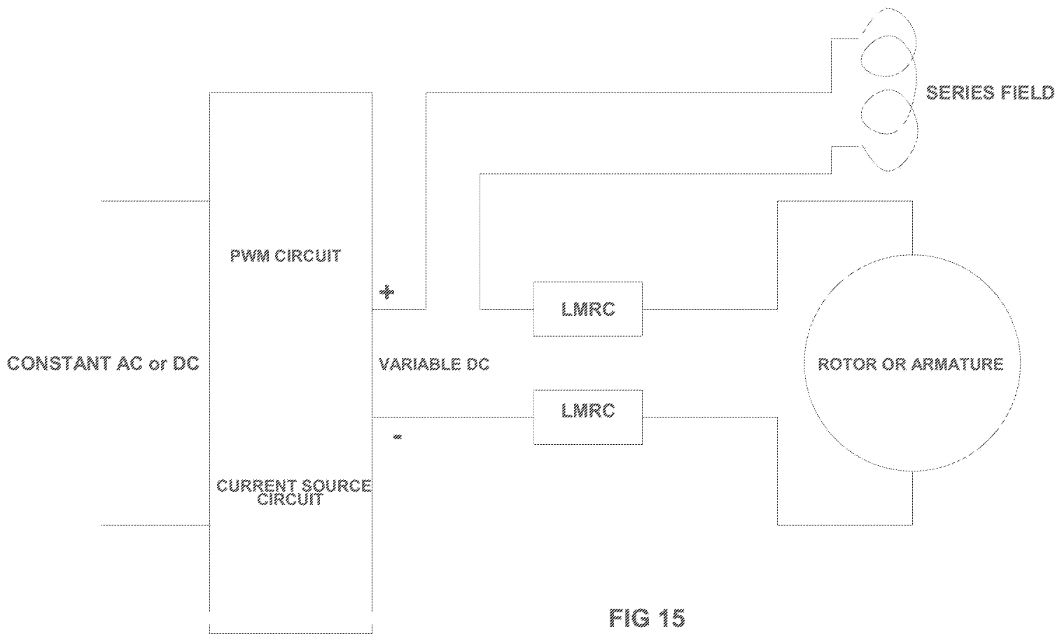

DC SERIES MOTOR: DC series motor has unique starting and running torque characteristics which is not found in any other motor type. FIG. 15 shows the connection scheme for a DC series motor utilizing liquid metal rotating contact (LMRC). The rotor and stator are connected in series. The same scheme can be applied to sliprings when used. Same source of DC power is used for rotor (armature) and stator (field) connections. As shown the power supply subsystem provides DC power with variable voltage to the armature and the field, since they are connected in series by LMRC. When LMRC is used the rectification and filtering for the armature and field PWM circuit is done on the PSS and only distortion free DC is applied to the armature and field. The DC series motor speed is controlled by controlling the voltage applied to the armature and to the field winding of the motor.

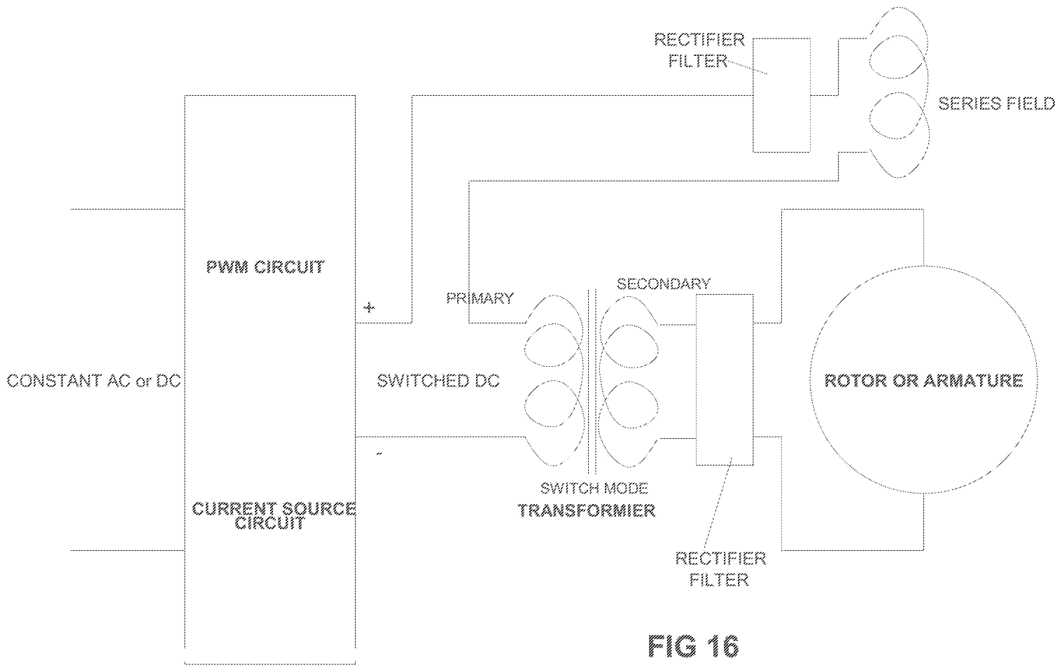

FIG. 16 shows the connection scheme for a DC series motor utilizing RSMT. The rotor and stator are connected in series by the primary of the RSMT. Same source of DC power is used for rotor (armature) and stator (field) connections since they are connected in series. As shown the power supply subsystem provides DC power with variable voltage to the armature and the field which are connected in series with the primary of the RSMT. The field winding is provide with rectification and filtering for the field circuit this will provide distortion free DC to the armature and the field. The RSMT for series motor is specially designed with the ability of the primary of the RSMT to handle both armature and field current in series. This design requires proper current rating for the primary of the RSMT and required turns ratio to induce required voltage in the secondary which is connected to the armature and provided with rectification and filtering for the field circuit which will provide distortion free DC to the armature. The DC series motor speed is controlled by controlling the voltage applied to the armature and to the field winding of the motor.

PERFORMANCE CHARACTERISTICS: the main characteristic of the series motor is high starting torque which is dependent on square of the armature current When constant voltage is maintained to the field circuit and variable voltage is supplied to the armature by PSS, a smooth speed control of the motor is achieved. Both speed and acceleration can be accurately controlled by this method.

It is also possible to control and achieve speed control by simultaneously varying both armature and field voltage.

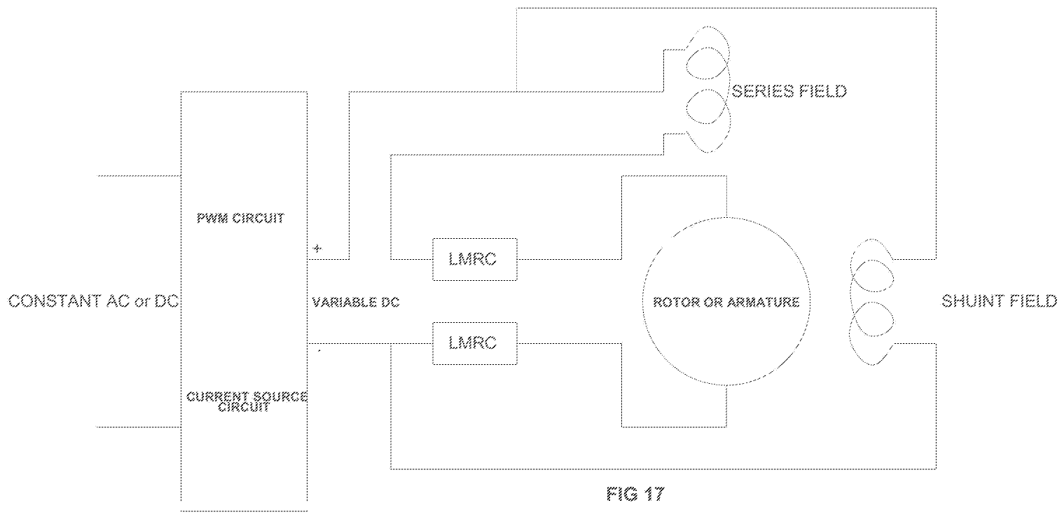

DC COMPOUND MTOR: FIG. 17 shows the connection scheme for a DC compound motor utilizing LMRC. The compound motor has a series winding and a shunt winding in addition to the armature winding located on the armature of the motor. The rotor and stator are connected in series by the LMRC. In addition, the shunt winding is connected in parallel to the armature by connecting to the input DC from the PSS as shown in FIG. 17. Same source of DC power is used for rotor (armature) and stator (field) connections since they are connected in series. Same source of DC power is also connected to the shunt winding. As shown the power supply subsystem provides DC power with variable voltage to the armature and the series field which are connected in series with the LMRC contacts and the armature winding. When LMRC is used the rectification and filtering for the armature and field PWM circuit is done on the PSS and only distortion free DC is applied to the armature and series and shunt field winding. The DC compound motor speed is controlled by controlling the voltage applied to the armature and to the series field and shunt field winding of the motor.

PERFORMANCE CHARACTERISTICS: the compound motor offers advantages of both shunt and series motor by providing high starting torque and good speed regulation. This is achieved by simultaneously varying both armature and field voltage. When variable voltage is applied to the compound motor by PSS, a smooth speed control of the motor is achieved. Both speed and acceleration can be accurately controlled by this method.

### Detailed Description of Superconducting DC Generator

Operating Principles of Superconducting DC Generator with Stator Coils with Right Angled Extension

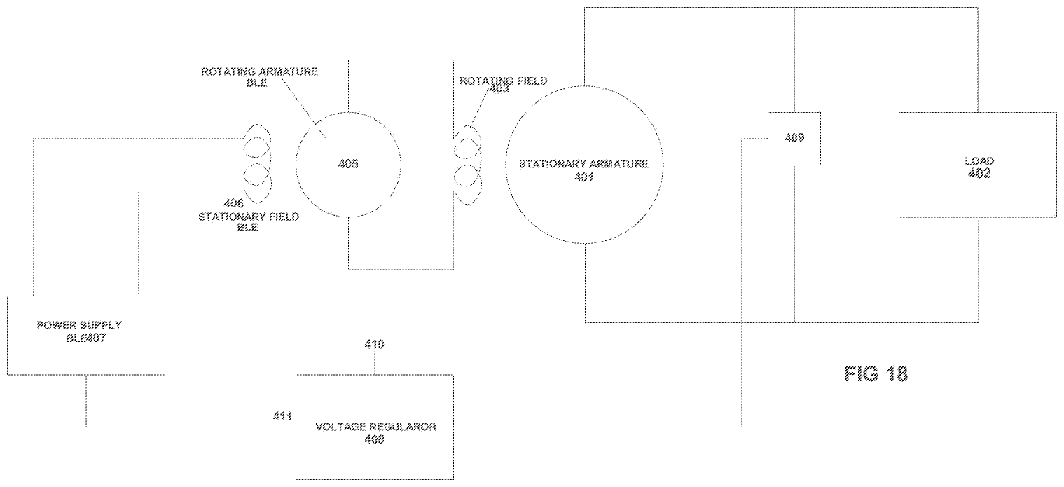

FIG. 18 shows the connection schematic for a superconducting DC generator according to the present application.

The DC generator 400 includes the following major parts working to obtain the required operation. For the generator action the term stator and armature and rotor and field are used interchangeably.

The armature coils 401 of the generator will be stationary and mounted on the machine housing. The armature will magnetically link a rotating field coil 403 mounted on shaft 404.

On the same shaft is also mounted a superconducting brushless exciter armature 405. The rotating armature magnetically links a stationary brushless exciter field coil 406. The rotating armature 405 of the brushless exciter provides excitation power to the generator field coil 403.

A voltage regulator 408 is used to control the output voltage of the generator under changing load conditions. Function and technology of the voltage regulator 408 is known in prior art and will not be repeated in detail.

The brushless exciter field coil 406 is connected to a field coil power supply 407.

The power supply is controlled by a voltage regulator 408. The voltage regulator has 3 primary inputs and one output.

The output voltage of the generator is monitored and sampled by 409 and is an input the voltage regulator 408.

The output voltage of the generator is compared with target reference voltage 410 and is an input the voltage regulator 408.

An error signal 411 is generated from the voltage regulator 408 based on the deviation of output voltage from the target reference and provides information to field coil power supply 407 to change the power input to the field coil to adjust the voltage output to the target reference.

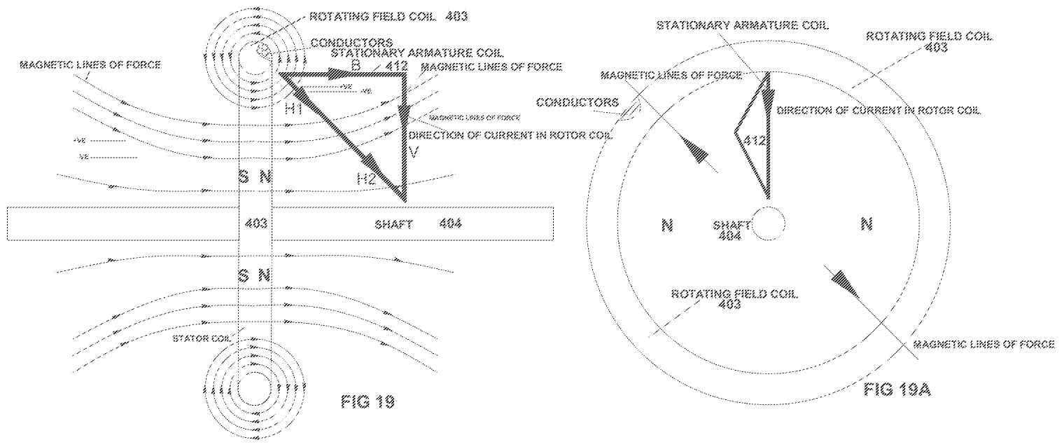

FIGS. 19 and 19A shows the principle of generator action according to the present application. A rotating field coil 403 will generate magnetic field as shown in FIGS. 19 and 19A.

The rotating field coil 403 is mounted on shaft 402. And the rotating shaft 402 is assembled as shown in FIGS. 19 and 19A. One instance of armature coils 401 is positioned as stationary coil 412 as shown in FIGS. 19 and 19A with sides B, V and right-angle extensions H1 and H2. FIGS. 19 and 19A shows the direction of current which is produced as a result of voltages generated in coil sides B, V and H1 and H2. The coil 412 is mounted on the generator housing as shown in FIGS. 19 and 19A. The generator coil configuration is selected whereby the coil side B of coil 412 is mounted parallel to the shaft. This will provide flux linkage with the rotating stator coil 403. Only one coil is shown to describe the principle of operation but in actual practice a large number of coils are assembled to meet desired specifications. These coils link the magnetic field generated by the rotating field coil 403. It is important to recognize that although coil with the right-angled extension is described in this embodiment, it is also possible to adopt different coil configurations of armature for generator action. Armature coil with triangular configuration and mounted parallel to the field coil can be used as well as any other suitable coil design.

When the rotating field coil is supplied with DC excitation current and the coil is rotated in the clockwise direction looking from right to left of this page towards the center of the shaft 402, as shown in FIGS. 19 and 19A the following actions take place.

Applying Fleming's right hand rule of the generator action to Sides B of the coil 412 which is parallel to the shaft 402 and it will be observed that this action will cause the voltage to be generated in the coil sides V and H1, H2 of coil 412, one example of the direction of which is indicated in FIGS. 19 and 19A. The voltage induced in each coil side will depend on the direction of rotation of coil and on the direction of magnetic field each coil side links. The direction of induced voltage produced by each coil side will be determined by the Fleming's right-hand rule of generator action and this action will produce final effect on the direction of voltage induced in coil 412.

Looking at the coil 412 from right to left of this page towards the center of the shaft 404 the direction of voltage in the coil 412 may be as shown in FIGS. 19 and 19A. Applying the Fleming's right-hand rule of generator action, the coil side B of coil 412 will generate the voltage with the polarity indicated in FIGS. 19 and 19A and the same time the coil side V of coil 412 will also generate the voltage indicated in FIGS. 19 and 19A. The polarity of the voltage generated in side B of coil 412 will be from left to right of this page and the polarity of the voltage generated in side V of coil 412 will be from top to bottom of this page. The voltage and resulting current flowing in side B of 112 will be in same direction to the voltage induced by side V of the coils 412. In a similar manner applying the Fleming's right-hand rule of generator action to the coil sides H1 and H2 of coil 412, will determine the voltage generated in coil sides H1 and H2. The voltage direction of H1 and H2 indicated in FIGS. 19 and 19A is only one example of voltages generated by the coil sides H1 and H2. The actual voltage generated in sides H1 and H2 may be different from that shown in FIGS. 19 and 19A and can be only determined by the Fleming's right-hand rule of generator action. The voltage in side B of coil 412 will add to the voltage induced by side V of the coil 412. The right-angled extension H1 may generate voltage in direction and magnitude which may be different than the direction of the voltage produced by sides B and V. In a similar manner the right-angled extension H2 of multisided coil 302 may generate voltage in direction and magnitude which may be different than the direction of the voltage produced by sides B and V. These two voltages generated by H1 and H2 may be in different direction and magnitude than voltage generated by sides B and V and may not result in a net voltage produced by coil sides H1 and H2. The final voltage generated and resulting current by the coil may be mainly the sum of voltage generated by coil sides B and V.

The final output voltage will be the difference between the sum of voltage generated by sides B and V and the voltage generated by the sides H1 and H2. The voltage generated by sides H1 and H2 will be dependent on the direction of magnetic field for the fixed direction of rotation and the position of the coil in the generator. The actual value of the voltage and the polarity of voltage developed in the coil sides H1 and H2 may be different than described in FIGS. 19 and 19A. The final value of output voltage developed by the coil with right angled extension will be determined by the Flemings right-hand rule of generator action and the difference between the sum of voltage generated by sides B and V and the actual voltage and polarity or direction of voltage in the coil sides H1 and H2.

By selecting the flux density generated by field coil 3 and the number of turns of field and armature coils and dimensions of the sides B, V and H1 and H2, the generator will be able to produce desired values of voltage and power output of the generator. It is possible to generate voltages in the range of 1000 KV or higher which will not require step-up transformer and DC voltages can be transmitted directly. The fully cryogenic design of the generator will eliminate rotor coupling for refrigerant and associated cost, reliability problems and maintenance involved.

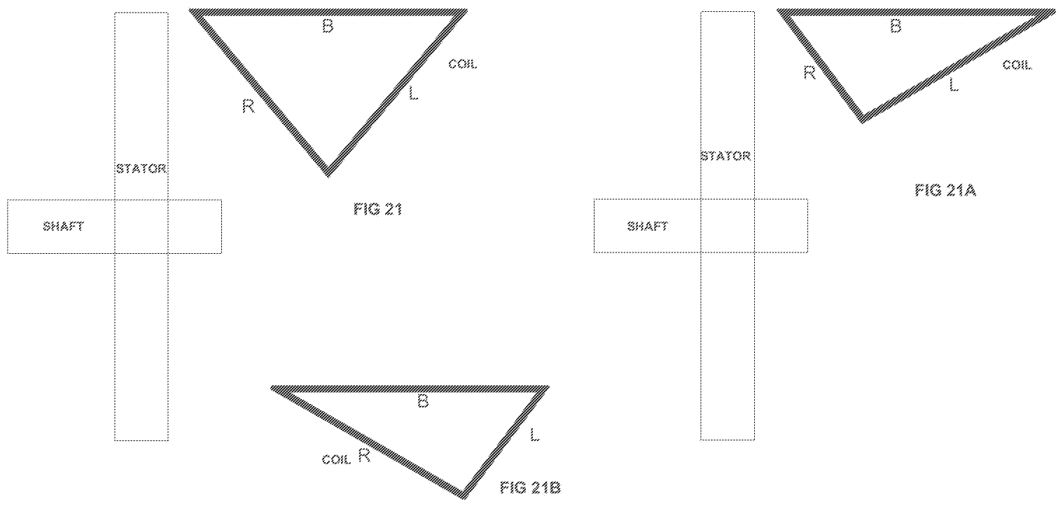

Different designs of rotor coils can be employed to design the rotor. One design will be a straight right-angled triangular coil without the right-angled extension. Where the final voltage generated will be the sum of vertical side and the base of the triangle minus the voltage generated by the hypotenuse side of the coil. Second configuration in generator action will be coil described in FIGS. 21, 21A and 21B. The voltage generated will be the voltage generated by side which is parallel to the shaft. Two other sides will mostly cancel each other because the voltage generated in the two sides will be in opposite direction. The final voltage will be the voltage generated by side B and the difference of voltage generated by sides R and L.

Generator Action with Two Opposing Stator Coils of Like Polarity

FIGS. 33, 33A, 34, 34A, 34B and 34C describes the embodiments of a motor with two opposing stator coils with poles of like polarity interacting with rotor coils.

The principles of motor action can also be applied to generator action by reversing the function of the stator and rotor. Coils described in FIGS. 33 and 33A can be operated as stationary armature of generator by assembling them on stationary armature and rotating the two coils of opposing polarity linking this coil. Also Coils described in FIGS. 34 and 34A can be operated as stationary armature of generator by assembling them on stationary armature and rotating the two coils of opposing polarity linking this coil.

In the generator action the field coils may be rotating and the field excitation power may be supplied with proper exciter action as described earlier. The output power may be produced by the stationary armature coils.

It will be observed that power output and power density available with the present invention is much higher than the prior art superconducting generators. These design concepts and fully cryogenic refrigeration will more than double the power density and thus power output of the generator of the same size available in prior art superconducting generators.

Construction and Assembly of Superconducting DC Generator with Stator Coils with Right Angled Extension

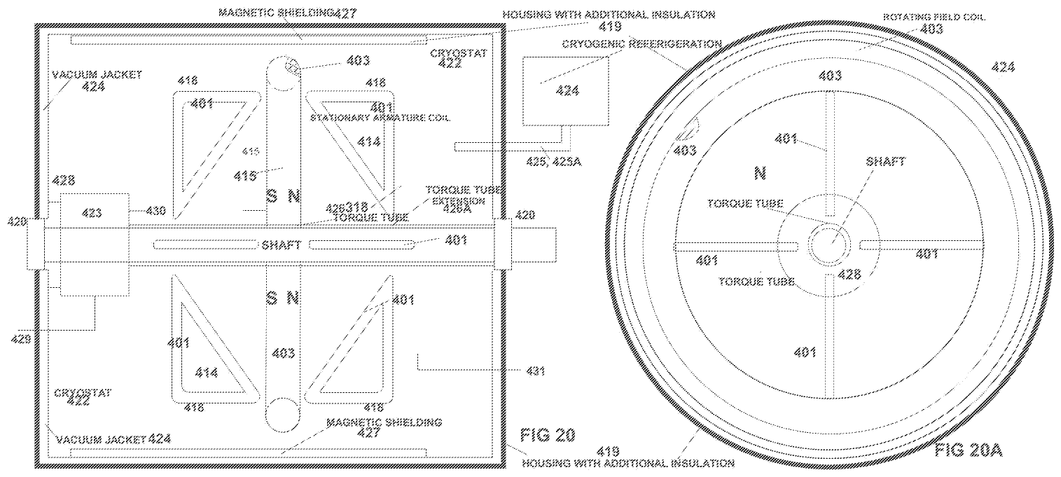

FIGS. 20 and 20A show the construction and integrated assembly of a superconducting DC generator with stationary armature coils 401 with right angled extension magnetically linking the rotating field coil 403 mounted on shaft 404.

The generator includes an armature (stator) assembly 414 and a field (rotor) assembly 415. The rotor assembly 415 is mounted on a rotating shaft 404 and the rotor assembly rotates as it magnetically links the armature assembly 414 by suitable airgaps depending on the design of field coil 403 and armature coil 401. The magnetic field produced by one pole of the field coil 403 is returned to the other pole by flux return path 417. The armature assembly is supported by armature supports 418. Both the armature 415 and field 415 assemblies are mounted inside a motor housing 419. The rotating shaft 404 is located on the housing by two bearings 420 as shown in FIGS. 20 and 20A. A vacuum jacket 421 with extra insulation creates a structure within the housing 419. The superconducting armature assembly 414 and field assembly 415 are mounted inside this structure. This structure is defined as low temperature cryostat.

For smaller rating motors and generators, the vacuum jacket is fabricated from stainless steel. However, for high power applications, the vacuum jacket is fabricated from a nonmagnetic composite material such as a fiber reinforced epoxy, either by filament winding or by manually. In one embodiment, the inner and outer vessels of the vacuum jacket are fabricated of a non-magnetic composite material.

Both the stator coil 114 and rotor coils 115 may be wound with HTS 2G superconducting wires. This may allow motor operation at or below 77K.

422. The function of the cryostat 422 is to maintain superconducting temperatures for the armature coils 401 and field coil 403 to maintain superconducting properties to conduct superconducting currents and maintain flux. Both the armature coils 401 and field coil 403 are preferably wound with HTS 2G superconducting wires. This may allow motor operation at or below 77K.

Both the stator coil 114 and rotor coils 115 may be wound with HTS 2G superconducting wires. This may allow motor operation at or below 77K.

Installed on the shaft 404 is also a brushless exciter unit (BEU) 423. The BEU has a rotating armature and a stationary field. The stationary field is mounted on the housing 419 and the rotating armature is mounted on the shaft 404. The schematic and operation of brushless exciter unit is described earlier in FIG. 18. DC excitation power is applied to the stationary field coil of the BEU423 and electrical power is produced by the generator action. The output of the BEU armature is connected to the generator field coil

403. Since high air gap sheer stresses will be generated this will result in high mechanical forces on the rotor coils 403. It is therefore important to wind the rotor coils 403 in a high strength coil former made from high strength suitable material and impregnated with epoxy resins. The input to the rotating filed coil is DC.

A closed loop Cryogenic refrigeration system 424 as shown in FIGS. 20 and 20A is located outside the generator housing and is connected to the cryostat by refrigerant transfer tube 425A and return tube 425B as shown in FIGS. 20 and 20A. The cryogenic refrigeration system 424 conducts heat from the armature coils 401 and the field coil 403 to the cryogenic refrigeration system 424, where the heat is dissipated. Cryogenic refrigeration system 424 maintains superconducting temperatures inside the cryostat 422 by circulating cryogenic refrigerant at superconducting temperatures. This keeps the field coil 403 and armature coils 401 in the superconducting state.

The field coil 403 is connected to the shaft 404 by means of torque tube 426 and the outer surface of the torque tube also forms the support structures for the field coil 403. The function of torque tube 426 is to transfer the torque provided by the generator drive shaft 404 to the field coil 403. The torque tube 426 also acts as a heat shield between the cryostat and the shaft 404 exposed to outside warm temperatures. This reduces the thermal load on cryogenic refrigeration system. The separate sections of the shaft 404 where coil is not mounted contains torque tube extensions 426A which also insulates cryostat from the sections of shaft 426 exposed to warm temperatures.

An electromagnetic shield 427 is fabricated around the field coil assembly 415 and is attached to vacuum jacket 421. The armature assembly 414 is secured to the housing 419 by stator supports 418.

Under the description of operating principles for rotor coils 115 perpendiculars to the stator coil 114 is described in detail how different electromagnetic mechanisms generate the required torque for the rotor coils 115.

### Special Coils for Brushless Commutatorless DC Motor and Generators

FIGS. 21, 21A and 21B show embodiments of coils that have not been described earlier for both the motors and generators. FIG. 21 shows a coil where the coil side B is parallel to the shaft and the coil is vertical to the stator. In this coil the flux from the stator will interact with all the three sides and the final torque for motor and voltage for the generators will be determined by the Flemings left and right-hand rules for motor and generator.

FIGS. 21A and 21B show the embodiment where the coil side B is parallel to the shaft and sides L and R are of unequal lengths. Unequal length will also allow voltage generated by sides L and R to be controlled. This will allow the resultant voltage to be selected at the desired value. This will also allow the coil sides L and R to be of smaller lengths and thus decreasing the total length of superconducting wires and positioned at a higher distance from the shaft than the coils described in FIGS. 2A, 2B and 2C.

In a similar manner the principles of motor action can also be applied to generator action by reversing the function of the stator and rotor. Armature coils described in FIGS. 4 and 4A can be operated as stationary armature of generator by assembling them on stationary armature and rotating the field coil linking this coil.

It is possible to design many different configurations of the coils that can be employed in the motors and generators according to this invention. Important principle to be remembered in the design is that sides that that generate torque for the motor and voltage for the generator should produce the required result by neutralizing the effect of the sides that produce opposite result.

### Armature Reaction in Dc Motors and Generators

The effect of armature reaction in motors and generators is to weaken and distort main field due to magnetic field produced by the armature currents. The major effect of armature reaction is on the commutation. Since there is no commutation in the commutatorless motors and generators of the new invention no detrimental effect is produced on the operation of DC machines. By adding extra ampere turns on the main filed the effect is largely reduced.

### Detailed Description of Iron Core Brushless Communtatorless DC Motor

CONVENTIONAL COPPER WOUND MOTOR: An iron core wound with industry standard copper wires used in electric motor industry is used in the brushless comutatorless motor according to the present invention. The brushless comutatorless motor offers advantages in terms of increased power density, superior performance and lower cost not achievable with existing DC machines with iron core and copper wound armature and field coils. The conventional copper wires used in the motors according to the present invention are special magnet or motor winding copper wires. Once the motor design parameters based on selected specification are defined, the copper wires are selected on the basis of the size of the conductor, thickness of insulation and type of enamel and its thermal class. These wires will be defined as conventional copper wires to distinguish these wires from the superconducting wires for the present invention. The iron used in the core should be low reluctance iron used in motor industry. Since there are no frequency dependent iron losses in the stator or the rotor, no laminations are required in the iron core.

Because of negligible frequency dependent iron losses, it is possible to use magnetic iron core material with flexible magnetic properties.

In one embodiment of the motor a permanent magnet stator or stationary field is used with a triangular or multisided armature coil with a copper armature winding mounted on a rotating shaft.

### Operating Principles of Permanent Magnet Stator Iron Core Armature Brushless Commutatorless DC Motor

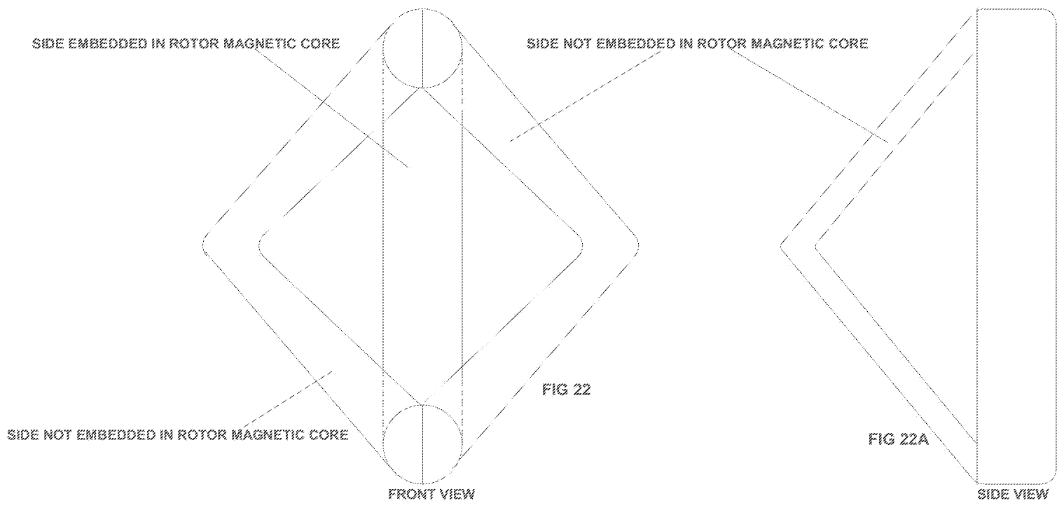

FIG. 22 shows a triangular coil with wires of coil sides L and R divided in the middle of the coil sides and separated as shown in FIG. 22. This coil will be defined as a bifurcated coil. The purpose of this special coil configuration is to allow only the coil side B to produce torque for the motor. A stationary disc type permanent magnet field will be used to demonstrate the principle of operation.

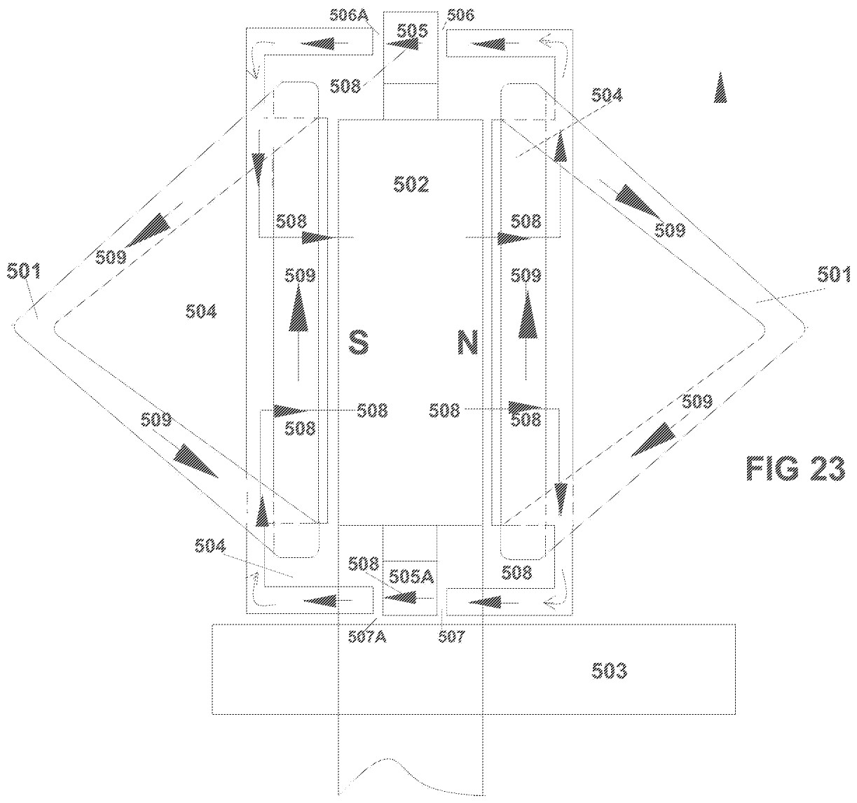

The bifurcated coil is used in the rotating armature. The armature coil is provided with a magnetic core made up of a flux conducting material as shown in FIG. 23 and rotates with the coil. One coil is provided as shown in FIG. 23. The purpose of the armature magnetic core is to receive magnetic flux from the stator pole of a selected polarity through an air gap and distribute the flux received form the selected pole to the pole of the opposite polarity of the stator thru two more airgaps to complete the magnetic circuit.

A magnetic core is also provided on the stator to transfer flux from one coil through two airgaps to the coil located on the other side of the permanent magnet as shown in FIG. 23.

This arrangement of the stator poles and rotor coils will produce torque in the same direction by all the coils of the motor armature as the armature rotates.

As shown in FIG. 23 the motor consists of a disc type permanent magnet stator 502. A shaft 503 passes through the inner opening of the stator magnet 502. A Triangular coil 501 is provided on each side of the stator 503 and mounted on the rotating shaft 503 as shown in FIG. 23. The coils 501 are each provided with magnetic core 504 as shown in FIG. 23. Two magnetic cores 505 and 505A are also provided on the stator 502. Stator core 505 is provided above the stator 502 and core 505A is provided in the inner opening of the stator magnet 502 as shown in FIG. 23. Alternately a core can also be provided on the rotor shaft which links the armature magnetic core 504. The function of the armature magnetic core 504 and the stator magnetic cores 505 and 505A is to allow flux from one pole of the motor to the opposite pole of the motor. Air gaps 504A and 504B are provided on each side of the stator 502 to allow flux from the stator north pole to propagate to armature core 504 as shown in FIG. 23. Flux originating from North Pole of the stator is propagated to the magnetic core 504 by an air gap 504A. After that the magnetic flux from the magnetic core 504 of the rotating coil 501 on one side is propagated to the stationary stator magnetic core 505 by an air gap 506 as shown in FIG. 23. The magnetic path is complete when the Flux from magnetic core 505 is transferred to the armature core on the South Pole side of the stator by an airgap 506B.

In a similar manner flux transfer takes place from the North Pole side of the stator to the south side of the stator by airgap 504A to 504 to airgap 507, 507A to stator core to airgap 504B to the South Pole side of the stator.

When the armature coils 501 are provided with DC current the following actions take place. Flux enters from the North Pole to armature core 504. As shown in FIG. 23, the side B of the coil has current as shown going vertically from the shaft to the stator core side. The flux from the stator north pole to armature propagates horizontal to the shaft. This will allow the current in the side B to interact with the flux at a perpendicular disposition.

Applying Fleming's left-hand rule of motor action and looking from the right to left of this page towards the center of the shaft and when the vertical current in coil interacts with the horizontal flux from the North Pole the coil will experience torque in a clockwise direction.

In a similar manner Applying Fleming's left hand rule of motor action and looking from the right to left of this page towards the center of the shaft and when the vertical current in coil interacts with the horizontal flux going to the South Pole side of the stator the coil will also experience torque in a clockwise direction.

It is important to understand that there are no frequency dependent iron losses in this motor architecture. This will reduce the heat produced and increase the efficiency of the motor. The copper losses are also reduced due to smaller coils. The power density is further increased since the armature conductors are active during 360 degrees of rotation. This will produce DC motor action with characteristics of permanent magnet DC motor.

### Construction and Assembly of Permanent Magnet Stator Iron Core Brushless Armature Commutatorless DC Motor

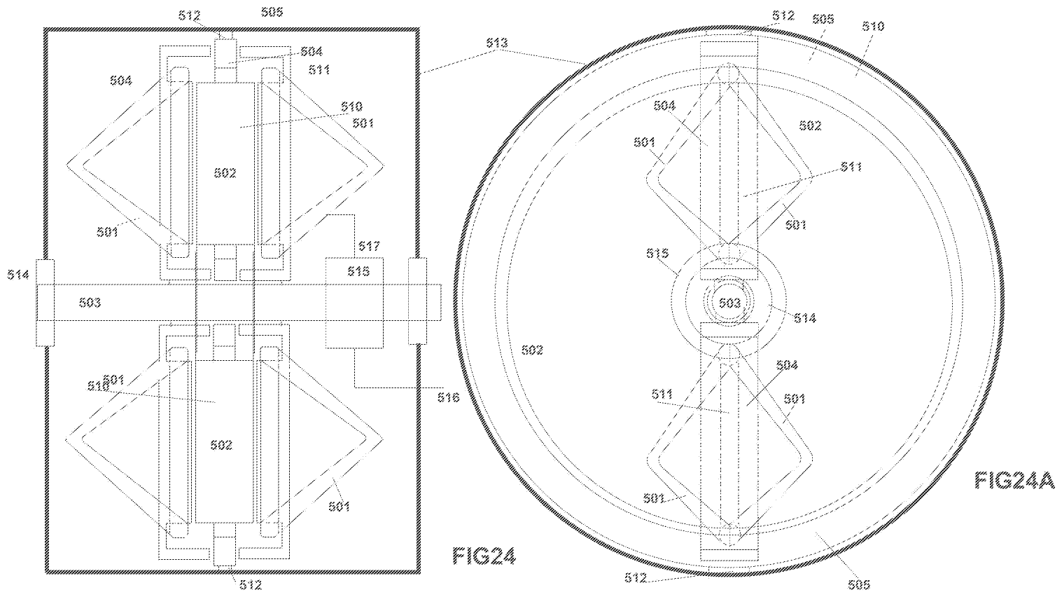

FIGS. 24 and 24A show the construction and integrated assembly of an iron core armature, permanent magnet motor with bifurcated armature coils perpendicular to the stator.

The motor includes a stator assembly 510 and an armature (rotor) assembly 513. The rotor assembly 513 is mounted on a rotating shaft 503 and the rotor assembly rotates as it magnetically links the stator assembly 510 by airgaps 506, 506A, 507, 507A. The magnetic field produced by one pole of the stator is returned to the other pole by flux return path as shown in FIG. 23. The stator assembly is supported by stator supports 512. Both the stator and rotor assemblies are mounted inside a motor housing 513. The rotating shaft 503 is located on the housing by two bearings 514 as shown in FIGS. 24 and 24A.

Installed on the shaft 503 is also a rotor power unit (RPU) 515. The RPU 515 has a rotating member and a stationary member. The stationary member is mounted on the housing 513 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for rotor coils 501 perpendiculars to the permanent magnet stator as shown in FIGS. 23 and 23A is described in detail how different electromagnetic mechanisms generate the required torque for the rotor coils 501.

For the permanent magnet motor operation to take place the rotor coils 501 have to be connected to the RPU and provided with power from PSS. The rotor coils 501 are to be provided with power from the RPU 515 by one of 6 RPU 515 design configurations. The electrical motor with rotor coils 501 perpendicular to the stator 503 will operate with operational characteristics and various performance parameters determined by the characteristics provided by permanent magnet stator with wound coil configuration.

STARTING AND SPEED CONTROL OF DC MOTOR: With the motor provided with a permanent magnet stator 502 and the rotor coils 501 properly connected in a selected configuration and suppled with power per FIGS. 9 thru 17 following actions take place. Since there is no back emf produced in the rotor coils 115 a large starting current will be generated depending upon the design parameters of the motor. This current will be limited to safe limit by a dedicated circuit in the PSS and motor will be allowed to start and will produce stating torque depending on the motor design parameters. Once the motor starts the speed control is achieved by controlling the armature voltage by PSS. The starting and speed control characteristics of the motor are superior to any existing permanent magnet motor.

### Construction and Assembly of Wound Stator, Iron Core Armature Brushless Commutatorless DC Motor

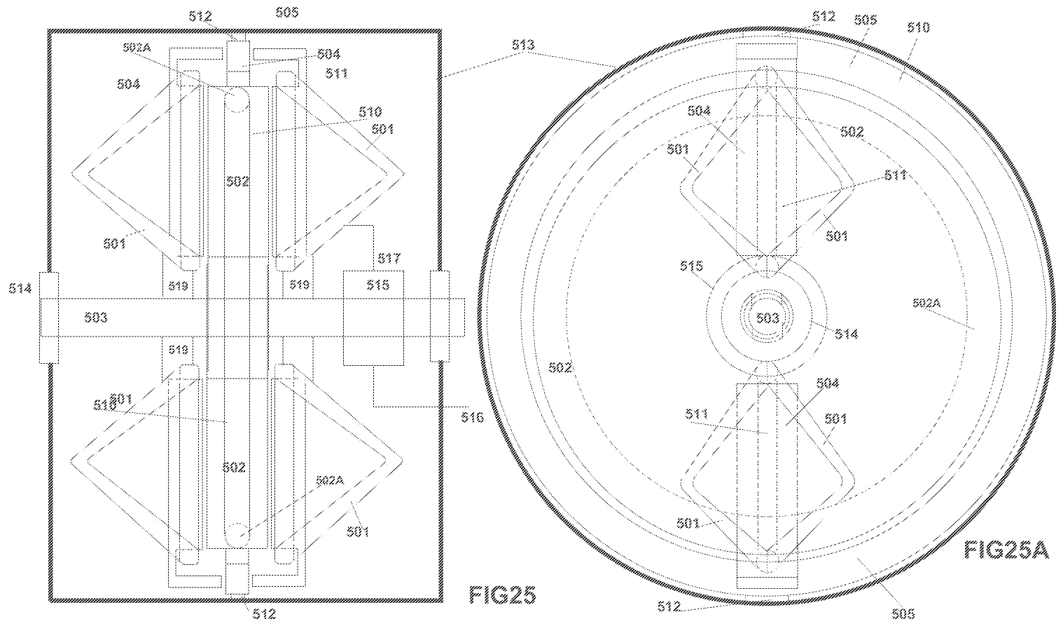

FIGS. 25 and 25A show the construction and integrated assembly of an iron core armature, wound stator motor with bifurcated armature coils perpendicular to the stator.

The motor includes a wound stator assembly 510 and an armature (rotor) assembly 511. The rotor assembly 511 is mounted on a rotating shaft 503 and the rotor assembly rotates as it magnetically links the stator assembly 510 by airgaps 506, 506A. In wound stator configuration stator core 505A and airgaps 507 and 507A are eliminated since there is no flux moving in that direction.

The magnetic field produced by one pole of the stator is returned to the other pole by flux return path as shown in FIG. 23. The stator assembly is supported by stator supports 512. Both the stator and rotor assemblies are mounted inside a motor housing 51. The rotating shaft 503 is located on the housing by two bearings 514 as shown in FIGS. 25 and 254A.

Installed on the shaft 503 is also a rotor power unit (RPU) 515. The RPU 515 has a rotating member and a stationary member. The stationary member is mounted on the housing 513 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for rotor coils 501 perpendiculars to the stator 502 as shown in FIG. 23 is described in detail how different electromagnetic mechanisms generate the required torque for the rotor coils 501. In wound stator configuration stator core 505A and airgaps 507 and 507A are eliminated since there is no flux moving in that direction.

### Operating Principles of Cylindrical Permanent Magnet Stator, Iron Core Armature Brushless Commutatorless DC Motor

FIG. 22 shows a triangular coil with wires of coil sides L and R divided in the middle of the coil sides and separated as shown in FIG. 22. This coil will be defined as a bifurcated coil. The purpose of this special coil configuration is to allow only the coil side B to produce torque for the motor. A stationary cylindrical type permanent magnet field will be used to demonstrate the principle of operation.

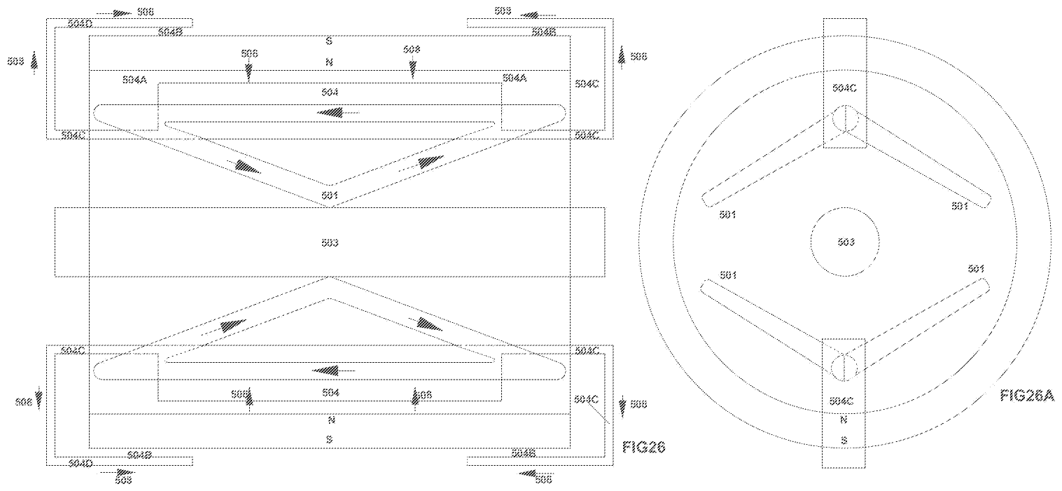

The bifurcated coil is used in the rotating armature. The armature coil is provided with a magnetic core made up of a flux conducting material as shown in FIG. 26 and rotates with the coil. One coil on each side is provided as shown in FIG. 26. The purpose of the armature magnetic core 504 is to receive magnetic flux from the stator pole N of a selected polarity through an air gap 504A and distribute the flux received form the selected N pole to the pole of the opposite polarity S of the stator thru airgap 504B to complete the magnetic circuit. The function of the armature coil magnetic core 504 is to allow flux from one pole of the motor to propagate to the opposite pole of the motor. Magnetic flux from the magnetic core 504 of the rotating coils is propagated to the pole of opposite polarity by an airgaps 504A and 504B as shown in FIGS. 26 and 26A. Two extensions of the armature core defined as armature core return paths 504C and 504D are formed in such a manner that it does not have direct contact with the stator magnet 502 as shown in FIGS. 26 and 26A. This extension 504C and 504D rotates as the armature rotates and links the opposite pole through an air gap 504B as shown in FIGS. 26 and 26A. The flux from the stator is first transferred to the armature core through the airgap 504A and the flux then passes through the extension of the armature core 504C and 504D to the second airgap 504B as shown in figure. From the airgap 504B the flux is transferred to the opposite pole. With these multiple paths the flux is transferred to the opposite pole thus completing the magnetic circuit. It will be observed and noted that by employing the multiple flux paths a complete magnetic circuit is formed offering the magnetic path of least resistance and providing the flux linkage with the conductors of armature coil 501.

This arrangement of the cylindrical stator poles and rotor coils will produce torque in the same direction by all the coils of the motor armature as the armature rotates.

As shown in FIGS. 26 and 26A the motor consists of a cylindrical type permanent magnet stator 502. A shaft 503 passes through the cylindrical stator magnet 502.

A Triangular coil 501 is provided on each side of the rotor 511 and mounted on the rotating shaft 503 as shown in FIG. 26. The coils 501 are each provided with magnetic core 504 as shown in FIG. 26. The function of the armature magnetic core 504 and the armature core return paths 504C and 504D is to allow flux from one pole of the motor to the opposite pole of the motor. Air gap 504A is provided between armature 501 and the stator 502 to allow flux from the stator north pole to propagate to armature core 504 as shown in FIG. 26. Flux originating from North Pole of the stator is propagated to the magnetic core 504 by an air gap 504A. After that the magnetic flux from the magnetic core 504 of the rotating coil 501 is propagated to the stationary stator by armature flux return core 504C and 504D and airgap 504B as shown in FIG. 26.

The magnetic path is complete when the Flux from armature flux returns cores 504C and 504D is transferred to the South Pole side of the stator by an airgap 504B. It is important to recognize that although two armature coils are shown in FIG. 26, according to the principles of the present invention the DC motor is capable of operating on only one armature coil.

When the armature coils 501 are provided with DC current the following actions take place. Flux enters from the North Pole to armature core 504. As shown in FIG. 26, the side B of the coil has current 509 as shown going horizontally from the right to left of the shaft as shown in FIGS. 26 and 26A. The flux 508 from the stator north pole to armature propagates vertical to the shaft. This will allow the current in the side B to interact with the flux at a perpendicular disposition.

Applying Fleming's left-hand rule of motor action and looking from the right to left of this page towards the center of the shaft and when the horizontal current 509 in coil interacts with the vertical flux 508 from the North Pole the coil will experience torque in anticlockwise direction.

It is important to understand that there are no frequency dependent iron losses in this motor architecture. This will reduce the heat produced and increase the efficiency of the motor. The copper losses are also reduced due to smaller coils. The power density is further reduced since the armature conductors are active during 360 degrees of rotation.

### Construction and Assembly of Cylindrical Permanent Magnet Stator, Iron Core Armature Brushless Commutatorless DC Motor

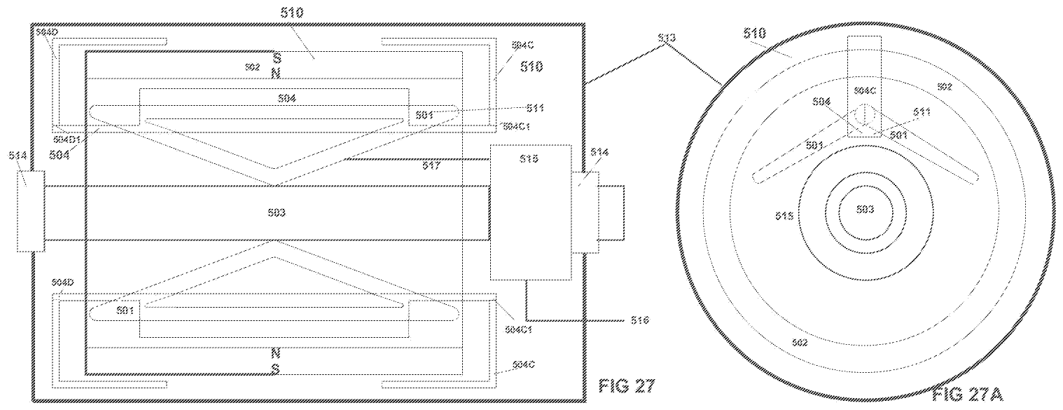

FIGS. 27 and 27A shows the construction and integrated assembly of an iron core armature, cylindrical permanent magnet motor with bifurcated armature coils where shaft is parallel to the cylindrical stator.

The motor includes a stator assembly 510 and an armature (rotor) assembly 511. The rotor assembly 511 is mounted on a rotating shaft 506 and the rotor assembly rotates as it magnetically links the stator assembly 510 by airgaps 504A and 504B. The magnetic field produced by one pole of the stator is returned to the other pole by flux return path as shown in FIG. 26. Referring to FIGS. 27 and 27A the flux from the North Pole is propagated to the South Pole by armature core 504 and flux return path 504C on one side and 504D on the other side. It will be observed that the stator is surrounded by armature magnetic paths formed by 504C and 504D. The stator and the armature assemblies cannot be assembled with flux return paths 504C and 504D because the flux return paths will obstruct the armature to be inserted in the stator opening. To avoid this and facilitate the assembly the flux return path 504C is divided into 2 sections by a joint 504C1. And the top section of 504C is not included in the first step of assembly. In the first step the armature is positioned with bearing on one side and without top section of 504C. Only after the armature is inserted the joint 504C1 assembles the top section of 504C to complete the magnetic path. The stator assembly is supported by stator supports 512. Both the stator and rotor assemblies are mounted inside a motor housing 513. The rotating shaft 503 is located on the housing by two bearings 514 as shown in FIGS. 27 and 27A.

Installed on the shaft 503 is also a rotor power unit (RPU) 515. The RPU 515 has a rotating member and a stationary member. The stationary member is mounted on the housing 511 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for permanent magnet cylindrical stator 502 with rotor coils 501 and shaft parallel to the cylindrical stator 502 as shown in FIGS. 26 and 26A is described in detail how different electromagnetic mechanisms generate the required torque for the rotor coils 501.

For the permanent magnet motor operation to take place the rotor coils 501 have to be connected to the RPU and provided with power from PSS. The rotor coils 501 are to be provided with power from the RPU 515 by one of 6 RPU 515 design configurations. The electrical motor with rotor coils 501 and shaft parallel to the cylindrical stator 502 will operate with operational characteristics and various performance parameters determined by the characteristics provided by permanent magnet stator with wound coil configuration.

STARTING AND SPEED CONTROL OF DC MOTOR: With the motor provided with a permanent magnet stator 502 and the rotor coils 501 properly connected in a selected configuration and suppled with power per FIGS. 9 thru 17 following actions take place. Since there is no back emf produced in the rotor coils 115 a large starting current will be generated depending upon the design parameters of the motor. This current will be limited to safe limit by a dedicated circuit in the PSS and motor will be allowed to start and will produce stating torque depending on the motor design parameters. Once the motor starts the speed control is achieved by controlling the armature voltage by PSS. The starting and speed control characteristics of the motor are superior to any existing permanent magnet motor.

### Construction and Assembly of Cylindrical Wound Stator, Iron Armature Brushless Core Commutatorless DC Motor

FIGS. 28 and 28A shows the construction and integrated assembly of an iron core armature, cylindrical wound stator motor with bifurcated armature coils perpendicular to the stator.

The motor includes a wound stator assembly 510 and an armature (rotor) assembly 511. The rotor assembly 511 is mounted on a rotating shaft 503 and the rotor assembly rotates as it magnetically links the stator assembly 510 by airgaps 504A and 504B.

The magnetic field produced by one pole of the stator is returned to the other pole by flux return path as shown in FIGS. 26 and 26A. The stator assembly is supported by stator supports 512. Both the stator and rotor assemblies are mounted inside a motor housing 511. The rotating shaft 503 is located on the housing by two bearings 514 as shown in FIGS. 28 and 28A.

Installed on the shaft 503 is also a rotor power unit (RPU) 515. The RPU 515 has a rotating member and a stationary member. The stationary member is mounted on the housing 511 and the rotating member is mounted on the shaft 503. DC or AC power is applied to the stationary member of the RPU 515 and electrical power is transferred to the rotating member electromagnetically. The output of the rotating member is connected to the rotor coils 501. The input to the rotor coils is DC.

Under the description of operating principles for cylindrical stator 502 and armature with magnetic core 504 and shaft parallel to the cylindrical stator 502 as shown in FIGS. 26 and 26A is described in detail how different electromagnetic mechanisms generate the required torque for the rotor coils 501. In wound stator configuration the stator 502 is magnetized by a stator coil 502A as shown in FIGS. 28 and 28A.

For the motor operation to take place the rotor coils 501 has to be connected to the stator coil 502 and the stator coil 502 is to be provided with power from PSS and rotor coils 501 is to be provided with power from the RPU 515 by one of 6 RPU 515 design configurations except the ones that use superconducting windings as described in the description CONNECTION SCHEMES FOR STATOR AND ROTOR FOR OPERATION OF SUPERCONDUCTING DC MOTOR and FIGS. 9 through 17. Since there are no superconducting windings in this configuration of stator and rotor the connection and parts using superconducting windings are excluded. In addition, FIGS. 9 through 17 also further describes 5 primary connection configurations by which rotor coils 501 are connected to stator coil 502. The electrical motor with rotor coils 501 perpendicular to the stator coil 502 will operate with operational characteristics and various performance parameters determined by connection between the stator coil 502 and rotor coils 501 by 5 major connection configurations described earlier. This enables the DC motor to obtain different operational characteristics.

STARTING AND SPEED CONTROL OF DC MOTOR: when stator coil 502 and rotor coils 501 are properly connected in a selected configuration and suppled with power per FIGS. 9 through 17 following actions take place. Since there is no back emf produced in the rotor coils 501 a large starting current will be generated depending upon the design parameters of the motor. This current will be limited to safe limit by a dedicated circuit in the PSS and motor will be allowed to start and will produce stating torque depending on the motor design parameters and connection configuration. Once the motor starts the speed control is achieved by methods described in FIGS. 9 through 17. The starting and speed control characteristics of the motor are superior to any existing wound stator motor.

Operating Principles of Superconducting Linear DC Motor with Armature Coils Parallel to the Stator Coil

Superconducting linear motors are not currently used in any major industry because of several limitations. With the availability of high flux densities and current densities for the linear motors according to the novel principles of the present application it is possible to achieve performance not available in any prior art linear motors.

An important aspect of the new superconducting linear motors is to offer alternate power and force production mechanisms for high operating force requirements for several applications. This is possible by replacing systems according to present the present invention with existing systems. This is achieved by replacing existing hydraulic systems with new innovative systems which do not have the complex systems, and is offered at lower cost and low maintenance requirements. Operating forces of 10,000 tons or more can be effectively developed by linear superconducting motor according to the present invention.

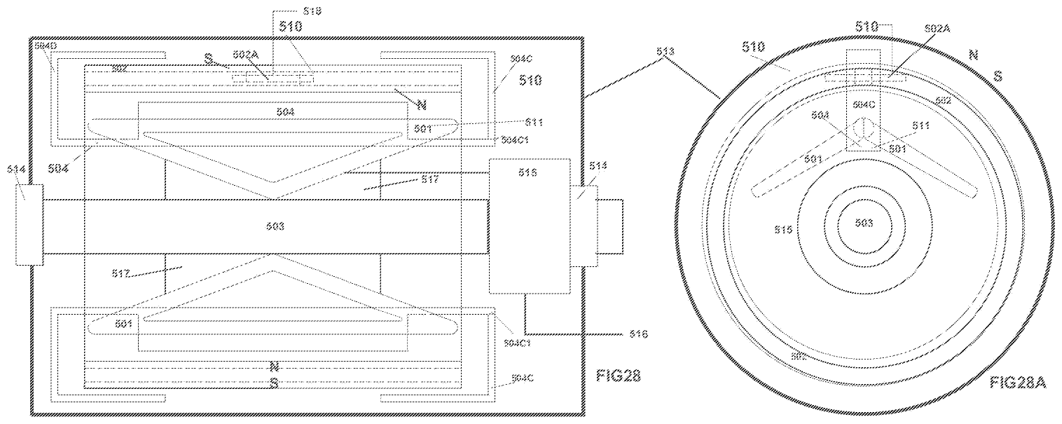

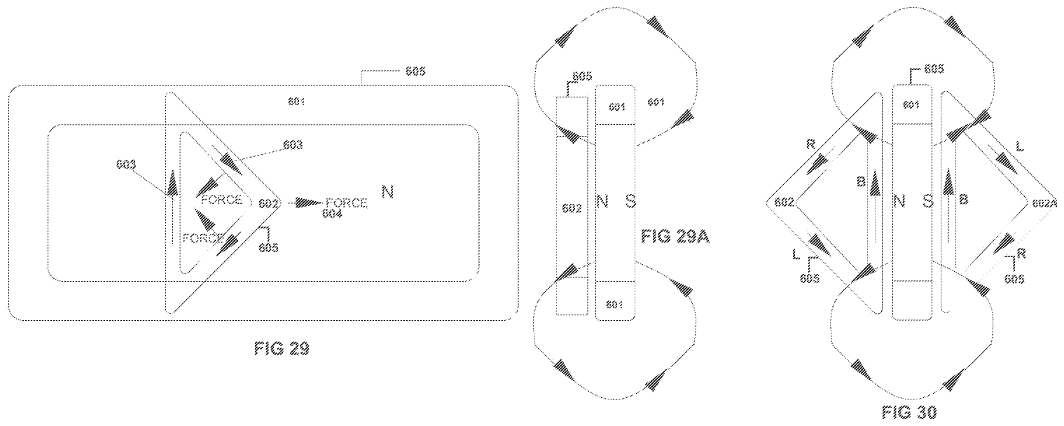

FIGS. 29 and 29A shows operating principles of the linear motors. A rectangular stator coil 601 is shown with magnetic field produced by this coil. Top of the coil has North Pole and bottom of the coil has South Pole. A linear armature is provided with a triangular coil 602 mounted horizontal with the stator coil 601. The current 603 flowing in coil side B is perpendicular to the magnetic lines of force generated by the stator coil 601. The direction of current 603 in coil 602 is as shown in FIGS. 29 and 29A. DC power 605 is provided to both the stator coil 601 and the armature coils 602.

The direction of flux in the stator coil is from the coil going upwards from the North Pole and then to the South Pole. The direction of current 603 in coil side B is from the bottom to the top of this page as shown in FIGS. 29 and 29A. This disposes the current flowing in coil side B perpendicular to the magnetic lines of force generated by the stator coil 601. Applying Fleming's left hand rule of motor action it will be observed that the direction of force 604 produced by the coil side B will be from the left to the right of this page. The direction of force produced by coil side R and L will be as shown in FIGS. 29 and 29A. The direction of the force produced by side R and L are in opposite direction and therefore they will cancel each other having negligible effect on the force produced by side B. Reversing the direction of current in coil or stator coil will reverse the direction of force generated by the coil.

Multiple coils can be mounted on the linear armature on both side of the stator to increase the thrust produced by the linear motor.

Operating Principles of Superconducting Linear DC Motor with Armature Coils Vertical to the Stator Coil

FIG. 30 shows an embodiment of a linear motor where the plane of the armature coils is perpendicular to the stator coil. A rectangular stator coil 601 is shown with magnetic field produced by this coil. Left side of the coil 601 has North Pole and right side of the coil has South Pole. A linear armature is provided with two triangular coils 602 and 602 mounted vertical with the stator coil 601. In this embodiment coils are provided on both the North Pole as well as south side of the stator coil 601 as shown in FIG. 30. The current flowing in coil sides B of 602 and 602A are perpendicular to the magnetic lines of force generated by the stator coil 601. The direction of current in coils 602 and 602A are as shown in FIG. 30.

Applying Fleming's left hand rule of motor action it will be observed that the direction of force 604 produced by the coil sides B of both the coils 602 and 602A will be from this page to the reader. The direction of force produced by coil side R and L will be determined by the Fleming's left-hand rule of motor action. The direction of the force produced by side R of 602 and L of 602A are in opposite direction and therefore they will cancel each other. Similarly, the direction of the force produced by side L of 602 and R of 602A are in opposite direction and therefore they will cancel each other. This will have negligible effect on the force produced by sides B of coils 602 and 602A. DC power 605 is provided to both the stator coil 601 and the armature coils 602 and 602A. Reversing the direction of current in coil or stator coil will reverse the direction of force generated by the coil.

The principles of motor action can also be applied to generator action by reversing the function of the stator and rotor. Coils described in FIGS. 28 and 28A can be operated as stationary armature of generator by assembling them on stationary housing and rotating the field coil linking the armature coil.

Construction and Assembly of Superconducting Linear DC Motor with Armature Coils Parallel to the Stator Coil

FIGS. 31 and 31A shows the construction and integrated assembly of a superconducting DC linear motor 600 with stationary stator coil 601 and armature coils 602 parallel to the stator coil 601. The DC linear motor includes a stator assembly 606 and an armature assembly 607. The armature assembly 607 is connected to a linear actuator and the armature assembly moves linearly on a linear bearing assembly 608 as it magnetically links the stator assembly 606 by airgap 601A. The linear bearing assembly should be insulated or capable of working in cryogenic temperatures. The magnetic field produced by one pole of the stator coil 601 is returned to the other pole to complete the magnetic path. Both the armature 607 and stator 606 assemblies are mounted inside a DC linear motor housing 609. A vacuum jacket 611 with extra insulation creates a structure within the housing 609. The superconducting armature assembly 607 and stator assembly 606 are mounted inside this structure. This structure is defined as low temperature cryostat 612. The function of the cryostat 612 is to maintain superconducting temperatures for the armature coils 602 and stator coil 601 to maintain superconducting properties to conduct superconducting currents and maintain flux. Both the armature coils 602 and stator coil 601 are preferably wound with HTS 2G superconducting wires. This will allow motor operation at or below 77K.

A closed loop Cryogenic refrigeration system 614 as shown in FIG. 31 is located outside the housing 609 and is connected to the cryostat by refrigerant transfer tube 614A and return tube 614B as shown in FIGS. 31 and 31A. The cryogenic refrigeration system 614 conducts heat from the armature coils 602 and the stator coil 601 to the cryogenic refrigeration system 614, where the heat is dissipated.

Cryogenic refrigeration system 614 maintains superconducting temperatures inside the cryostat 612 by circulating cryogenic refrigerant at superconducting temperatures. This keeps the stator coil 601 and armature coils 602 in the superconducting state.

The armature assembly 607 is connected to the linear actuator 610 by a thermal barrier 613 and this also forms the support structures for the armature coil 602. The function of thermal barrier is to transfer the force provided by the armature coils to the linear actuator and it also acts as a heat shield between the cryostat 612 and the linear actuator exposed to outside warm temperatures. This reduces the thermal load on cryogenic refrigeration system. An electromagnetic shield 615 is fabricated around the stator assembly 606 and is attached to vacuum jacket 611. The stator assembly 606 is secured to the housing 609.

The linear motion generated by is created by interaction of magnetic field of the stator coil and current in the armature coil. Power 605 to the stator coil 601 is provided directly by 605A and armature is provided power 605B from a stationary brush and sliding electrode with linear motion mechanism (not shown) located on armature assembly 607. The sliding electrode collects power from a stationary brush and transfers it to armature coil 602. Alternated method to transfer power to the armature coils 602 will be to use linear transformer. Design and construction of linear transformer is known in prior art.

Under the description of operating principles for armature coils 602 horizontal to the stator coil 601 is described in detail how different electromagnetic mechanisms generate the required linear force for the armature coils 602.

Principles of Operation and Construction and Assembly of Iron Core Linear DC Motor with Armature Coils Perpendicular to the Stator Coil

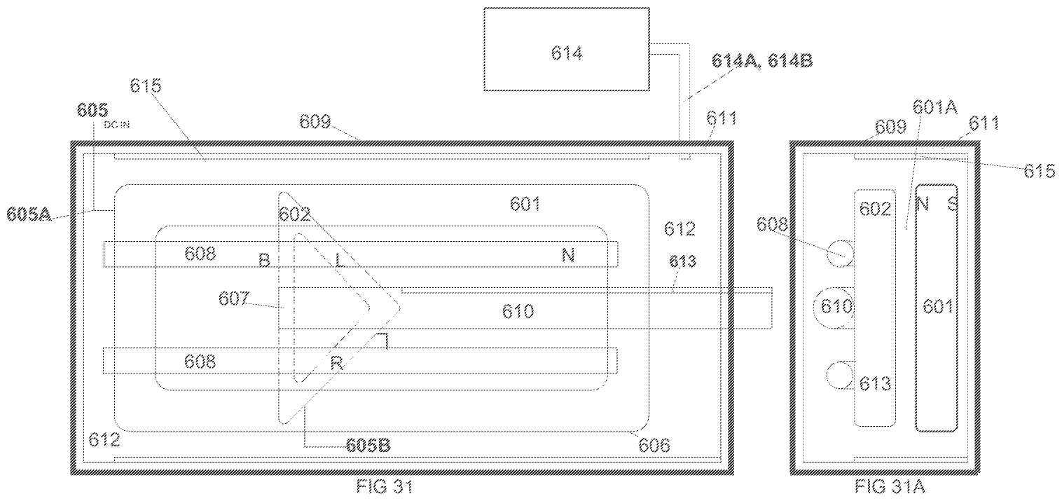

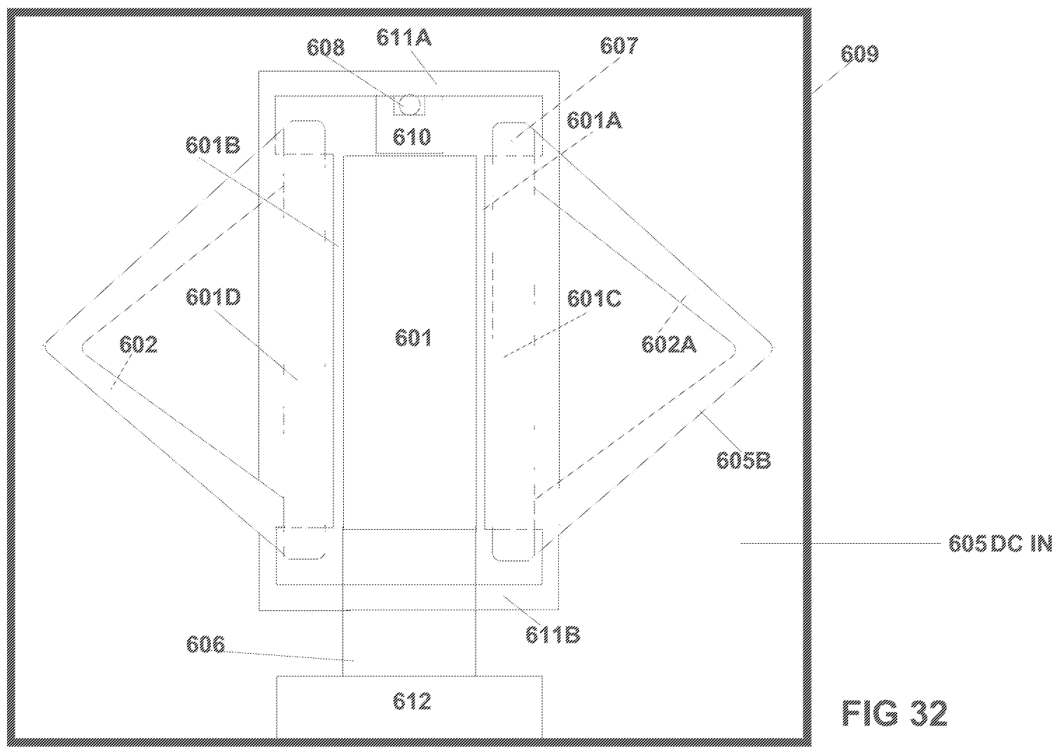

FIG. 32 shows the construction and integrated assembly of an iron core armature, permanent magnet stator linear motor with triangular armature coils perpendicular to the stator.

The linear motor includes a permanent magnet stator assembly 606 and an armature assembly 607. The stator assembly includes permanent magnet 601PM. The armature assembly 607 includes two armature coils 602 and 602A and is mounted on a linear bearing assembly 608 as it magnetically links the stator assembly 606 by airgaps 601A and 601B. The sides B of the armature coils 602 and 602A are enclosed inside magnetic cores 601C and 601D. This will allow the magnetic flux from stator to only link side B of the armature coils and return the flux to the opposite pole by flux return paths described in the description that follows. The magnetic flux from stator will not link sides L and R of the armature coils. This will enable only the side B of the armature coils to produce linear force.

The magnetic field produced by one pole of the stator 601 is returned to the other pole by flux return paths 611A and 611B as shown in FIG. 32. The stator assembly is supported by stator supports 612. Both the stator and armature assemblies are mounted inside a motor housing 609. A linear actuator 610 which transfers the operating force from the armature coil 602 and the armature assembly 607 to the required point of use is connected to the armature assembly 607.

The linear motion generated by is created by interaction of magnetic field of the stator and current in the armature coil. DC Power 605 to the armature is provided by 605B from a stationary brush and sliding electrode with linear motion mechanism (not shown) located on armature assembly 607. The sliding electrode collects power from a stationary brush and transfers it to armature coils 602 and 602B. Alternated method to transfer power to the armature coils 602 will be to use linear transformer. Design and construction of linear transformer is known in prior art.

It is also possible to produce linear motor action by only one armature coil perpendicular to the field coil as shown in FIG. 30. Only one coil 602A will be used and the coil 602A will be moved 180 degrees so that the apex of the triangle formed by sides R and L will be closer to the field coil and the side B will be on the other side at a greater distance from the field coil and parallel to the field coil. According to the Flemings left hand rule of motor action the linear force generated by the coil sides L and R will be in the opposite direction and will cancel each other. The linear force generated by the armature coil will be the force generated by the coil side B.

Another method of generating linear force will be identical to motor action created by two field coils as shown in FIGS. 34 and 34A. The two opposing stationary linear field coils with like polarity will be mounted on housing and an armature coil will magnetically link the two coils and linear force will be produced according to the Flemings left hand rule of motor action in similar manner described.

The present application should be understood by one skilled in the art as covering all embodiments of the motor both with superconducting windings as well as conventional copper windings.

It should be appreciated that features considered unique to the present application include DC motor performance superior to other prior art motors in many respects primarily in terms of higher torque and ease of speed control. Further, commutators and brushes contribute to higher costs for DC motors. The present application eliminates the need for commutators and brushes. In DC operation it offers better performance at lower cost by eliminating the need for commutation.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A superconducting brushless commutatorless DC electrical motor, comprising:
a machine housing;
a first stationary member having:
at least one field coil;
a field pole magnetic path mounted on the machine housing; and a
magnetic field;
a first rotating member having:
an armature magnetic path;
at least one armature coil having a plurality of coil sides; a second stationary member having:
a plurality of field system yoke magnetic flux conducting paths linking to the first stationary member;
a second rotating member having:
a plurality of armature yoke magnetic flux conducting paths linking to the first rotating member;
a shaft disposed along an axis around which the first rotating member rotates;
a torque tube assembly to transfer rotational force produced by the at least one armature coil to the shaft and provide thermal isolation and heat shield between the at least one armature coil and the shaft;
a power transfer device configured to transfer power to the first rotating member via a plurality of modes including rotary power transfer device, selected from the group consisting of
(A) a liquid metal rotating contact assembly, having at least one pair of stationary contacts located on the machine housing and at least one pair of rotating contacts located on the shaft wherein the least one pair of stationary contacts located on the machine housing and the at least one pair of rotating contacts located on the shaft are connected electrically by liquid metal and the rotating contacts the further connected to the at least one armature coil,
(B) a rotating transformer, having a primary winding located on the machine housing and a secondary winding located on the shaft and the primary winding located on the machine housing and the secondary winding located on the shaft are connected electromagnetically by transformer action and the secondary winding is further connected to the at least one armature coil utilizing a rectifier and filter circuit,
(C) a brushes and slipring assembly having at least one pair of stationary contacts located on the machine housing and at least one pair of rotating contacts located on the shaft and the at least one pair of stationary contacts located on the machine housing are connected electrically and the rotating contacts are further connected to the at least one armature coil, and
(D) a superconducting rotating transformer having a stationary superconducting primary winding and a rotating superconducting secondary winding having the primary superconducting winding located on the machine housing and the secondary superconducting winding located on the shaft and the superconducting primary winding located on the machine housing and the secondary superconducting winding located on the shaft are connected electromagnetically by transformer action and the secondary superconducting winding is further connected to the at least one armature coil utilizing a rectifier and filter circuit;
a cooling assembly configured to cool the field coil and the armature coil simultaneously in a sealed cryostat at superconducting temperatures by a closed loop cryogenic refrigeration system located outside the motor housing and connected to the cryostat by refrigerant transfer tube and return tube and the cryogenic refrigeration system conducts heat from the rotor coils and stator coil to the cryogenic refrigeration system where the heat is dissipated and the Cryogenic refrigeration system maintains superconducting temperatures inside the cryostat by circulating cryogenic refrigerant at superconducting temperatures where the cryogenic refrigerant keeps the stator coil and the rotor coils in the superconducting state;
wherein, the first stationary member magnetically couples to the first rotating member and the second stationary member magnetically couples to the second rotating member and the at least one coil of the first stationary member magnetically couples the at least one armature coil of the first rotating member;
wherein, DC brushless commutatorless motor operation having selected DC motor performance characteristics is produced by connecting the stator coil and the at least one armature coil in a selected connection configuration selected from the group consisting of
(E) a DC series motor having the stator coil and the armature coil connected in series by mode selected from the group consisting of
utilizing said liquid metal rotating contact assembly wherein the field coil and the at least one armature coil is connected in series by connecting the field coil and the stationary contacts in series and a selected DC terminal voltage is applied across the series connection of the field coil and the stationary contacts such that magnetic field produced by the field coil magnetically interacts with the at least one armature coil, utilizing said rotating transformer wherein the field coil is connected in series with the at least one armature coil by connecting the field coil and the primary of the rotating transformer in series and a selected DC terminal input voltage comprising time variant voltage is applied to the series connection of the field coil and the primary of the rotating transformer,
utilizing said brushes and slipring assembly wherein the field coil and the at least one armature coil is connected in series by connecting the field coil and the stationary contacts in series and a selected DC terminal voltage is applied across the series connection of the field coil and the stationary contacts, and
utilizing said superconducting rotating transformer wherein the field coil is connected in series with the at least one armature coil by connecting the field coil and the primary of the superconducting rotating transformer in series and a selected terminal input voltage comprising time variant voltage is applied to the series connection of the field coil and the primary of the superconducting rotating transformer,
(F) a DC shunt motor having the stator coil and the armature coil connected in parallel mode selected from the group consisting of
utilizing said liquid metal rotating contact assembly wherein the field coil and the at least one armature coil is connected in parallel by connecting the field coil and the stationary contacts in parallel and a selected DC terminal voltage is applied across the parallel connection of the field coil and the stationary contacts,
utilizing rotating transformer wherein the field coil is connected in parallel with the at least one armature coil by connecting the field coil and the primary of the rotating transformer in parallel and a selected DC terminal input voltage comprising time variant voltage is applied to the parallel connection of the field coil and the primary of the rotating transformer,
utilizing said brushes and slipring assembly wherein the field coil and the at least one armature coil is connected in parallel by connecting the field coil and the stationary contacts in parallel and a selected DC terminal voltage is applied across the parallel connection of the field coil and the stationary contacts, and
utilizing said superconducting rotating transformer wherein the field coil is connected in parallel with the at least one armature coil by connecting the field coil and the primary of the superconducting rotating transformer in parallel and a selected terminal input voltage comprising time variant voltage is applied to the parallel connection of the field coil and the primary of the superconducting rotating transformer,
(G) a DC compound motor having a series stator coil and a shunt stator coil and the at least one armature coil is connected in series with the series stator coil by mode selected from the group consisting of
of
utilizing said liquid metal rotating contact assembly,
utilizing said rotating transformer,
utilizing said brushes and slipring assembly, and
utilizing said superconducting rotating transformer,
and the shunt stator coil is further connected in parallel to the stationary contacts and a selected DC terminal voltage is applied across the series connection of the series field coil and the stationary contacts,
(H) a DC separately excited motor having the stator coil and the armature coil connected separately to the selected DC terminal voltage wherein the field coil is connected to a selected DC terminal voltage and the at least one armature coil is provided with selected input DC terminal voltage by mode selected from the group consisting of
utilizing said liquid metal rotating contact assembly,
utilizing said rotating transformer,
utilizing said brushes and slipring assembly, and
utilizing said superconducting rotating transformer,
wherein, brushless commutatorless operation is produced by said selected operating characteristics of DC motor operation obtained with selected said mode of connection between the stator coil and the at least one armature coil and electrical power applied by said selected mode of providing power to the field coil and the at least one armature coil;
wherein the first stationary member producing a magnetic field in a pattern linking the plurality of the coil sides of the at least one armature coil of the first rotating member wherein the magnetic field produced by the field coil magnetically interacts with the at least one selected coil side produces an electromagnetic force exerting rotational force on the shaft defined as torque on the shaft where direction of the electromagnetic force generated by each coil side is given by Flemings left hand rule of motor action; and
the magnitude of the force produced by each coil side
is given by the formula F=B×I×L;
where F=force in newtons,
B=flux density in tesla,
I=current in ampere,
L=no of turns in coil X length of each coil side;
wherein at least one selected coil side comprises, the electromagnetic force generating main rotational torque on the shaft in the selected direction and the electromagnetic force produced by remainder of the coil sides will be selected from the group consisting of
the coil side generating torque in the same direction as the selected coil side,
the coil side generating the torque in the opposite direction as the selected coil side, and
the coil side generating torque in a direction different from the direction of the torque generated by the selected coil side without having any effect on torque generated by the selected coil side;
wherein the total electromagnetic force generating the torque on the shaft comprises the electromagnetic force generated by the selected coil side and combined effect of the electromagnetic force generated by remainder of the coil sides in said selected configuration;
the electromagnetic force produced by each coil side having magnitude and direction will assume vector properties and electromagnetic force generated by each coil side can be resolved along selected X-axis and Y-axis into X and Y component of the electromagnetic force which be used to compute the torque generated on the shaft by each coil side;
wherein the X component of the total electromagnetic force generating the torque on the shaft comprises the sum of X component of the electromagnetic force generated by the selected coil side and the X components of the electromagnetic forces generated by remainder of the coil sides wherein the direction of the X component acting in the same direction as the X component of the selected coil side is given a positive sign and direction of the X component acting in the opposite direction to the X component of the selected coil side is given a negative sign; and
Wherein the Y component of the total electromagnetic force generating the torque on the shaft comprises the sum of Y component of the electromagnetic force generated by the selected coil side and the Y components of the electromagnetic forces generated by remainder of the coil sides wherein the direction of the Y component acting in the same direction as the Y component of the selected coil side is given a positive sign and direction of the Y component acting in the opposite direction to the Y component of the selected coil side is given a negative sign; and
wherein when the Y component of the electromagnetic force generating the driving torque on the shaft on all the coil sides is zero, only the X component is used for calculating the final electromagnetic force generating the driving torque on the shaft; and
when the X component of the electromagnetic force generating the driving torque on the shaft on all the coil sides is zero, only the Y component is used for calculating the final electromagnetic force generating the driving torque on the shaft;
wherein, the magnetic field is produced by a permanent magnet.

2. The superconducting brushless commutatorless DC electrical motor of claim 1, wherein the first stationary member includes:
a field coil made from HTS 2G superconducting conductors;
a cooling assembly to cool the field coil at superconducting temperatures; wherein the field coil is substantially circular shaped;
wherein the field coil is generally concentric with the shaft;
wherein the field coil is located to magnetically link the at least one armature coil made from HTS 2G superconducting conductors;
wherein the at least one armature coil has a plurality of coil sides including a horizontal coil side parallel to the axis of the shaft and vertical coil sides perpendicular to the axis of the shaft and the remainder of the coil side is formed into an apex of a triangle having two sections and the plane of the coil sides formed by the two sections in the form of the apex of the triangle is perpendicular to the plane formed by the horizontal coil side parallel to the axis of the shaft and the vertical coil side perpendicular to the axis of the shaft;
wherein the armature coil side parallel to the axis of the shaft and the vertical coil side perpendicular to the axis of the shaft and further comprises a torque tube assembly fabricated from Inconel transfers torque from the armature coils to the shaft and a machine housing comprises the cooling assembly fabricated from a nonmagnetic composite material simultaneously cooling the field coil and the armature coils at superconducting temperatures;
wherein a flux produced by the field coil travels along the shaft and interacts radially with the horizontal coil side parallel to the axis of the shaft and the vertical coil side perpendicular to the axis of the shaft;
wherein the main driving torque is produced by the horizontal coil side parallel to the axis of the shaft and the vertical coil side perpendicular to the axis of the shaft since the torque produced by the coil side formed in the shape of an apex of a triangle with the two sections contributes zero torque to the shaft wherein the torque is produced by the at least one armature coil producing continuous rotation,
wherein, brushless commutatorless operation is produced by said selected operating characteristics of DC motor operation obtained with selected said mode of connection between the stator coil and the at least one armature coil and electrical power applied by said selected mode of providing power to the field coil and the at least one armature coil.

3. The superconducting brushless commutatorless DC electrical motor of claim 1, wherein the at least one armature coil has a plurality of coil sides and the plane of the at least one armature coil is parallel to the plane of the field coil.

4. The superconducting brushless commutatorless DC electrical motor of claim 1, wherein the first stationary member includes one field coil and at least one armature coil having a plurality of coil sides with one side parallel to an axis of the shaft and the remainder of coil sides forming angle to the side parallel to the shaft and a torque tube assembly transfers torque from the armature coil to the shaft and a cooling assembly simultaneously cools the field coil and the armature coil at superconducting temperatures and the flux produced by the field coil interacting with armature coil side parallel to the axis of the shaft carrying current and radially moving flux interacts with the coil side parallel to the shaft and at least one coil side forming angle to the side parallel to the axis of the shaft producing force that can be resolved along only selected X-axis which to calculate the final rotational force exerted on the shaft producing the driving torque on the shaft,
wherein, brushless commutatorless operation is produced by said selected operating characteristics of DC motor operation obtained with selected said mode of connection between the stator coil and the at least one armature coil and electrical power applied by said selected mode of providing power to the field coil and the at least one armature coil.

5. The superconducting brushless commutatorless DC electrical motor of claim 1, wherein the first stationary member includes two field coils of like polarity opposing each other and at least one substantially triangular shaped armature coil having a plurality of coil sides with one side parallel to an axis of the shaft and perpendicular to the two field coils and a remainder of armature coil sides form an angle to the shaft and the two field coils and a torque tube assembly transfers torque from the armature coil to the shaft and a cooling assembly simultaneously cools the two field coils and the armature coil at superconducting temperatures and the flux produced by the two field coils of like polarity travel in opposite directions along the shaft and radially in relation to the shaft interacts with a horizontal armature coil side in a same direction and flux from the two field coils of like polarity moving in a opposite direction simultaneously interacting with the two armature coil sides forming angle to the shaft and carrying current in the opposite direction where the force producing main driving torque is produced by all the three coil sides, and a torque tube assembly transfers torque from the armature coils to the shaft wherein, brushless commutatorless operation is produced by said selected operating characteristics of DC motor operation obtained with selected said mode of connection between the stator coil and the at the least one armature coil and electrical power applied by said selected mode of providing power to the field coil and the at least one armature coil.

6. The superconducting brushless commutatorless DC electrical motor of claim 1, wherein the first stationary member includes two field coils of like polarity opposing each other and at least one armature coil having a plurality of coil sides with one side parallel to an axis of the shaft and perpendicular to the two field coils and a and two coil sides each parallel to one field coil of like polarity and linking the magnetic field of each coil moving in opposite direction and remainder of armature coil sides includes a plurality of coil side segments form an angle to the sides parallel to each field coil and the plane of coil side segments is perpendicular to each field coil and parallel to the shaft and the two field coils and a torque tube assembly transfers torque from the armature coil to the shaft and a cooling assembly simultaneously cools the two field coils and the armature coil at superconducting temperatures and the flux produced by the two field coils of like polarity travel in opposite directions along the shaft and radially in relation to the shaft interacts with a horizontal armature coil side in a same direction and flux from the two field coils of like polarity moving in a opposite direction simultaneously interacting with two armature coil sides parallel to the field coils carrying current in the opposite direction and the radially moving flux interacts with the coil side segments producing force that can be resolved along selected X-axis and Y-axis which can be combined with the force produced by the coil sides parallel to field coils to calculate the final force producing the rotational torque on the shaft,
wherein, brushless commutatorless operation is produced by said selected operating characteristics of DC motor operation obtained with selected said mode of connection between the stator coil and the at least one armature coil and electrical power applied by said selected mode of providing power to the field coil and the at least one armature coil.

7. The superconducting brushless commutatorless DC electrical motor of claim 1, wherein the first stationary member includes a coil made from conventional copper conductors and a magnetic field is produced by mode selected from group consisting of
a permanent magnet, and
a field coil to produce a magnetic field.

8. The superconducting brushless commutatorless DC electrical motor of claim 1, wherein the first stationary member to produce a magnetic field is in a cylindrical form and the magnetic field is produced by mode selected from group consisting of
a permanent magnet, and
a field coil made from conventional copper conductor to produce a magnetic field,
wherein at least one armature coil is substantially triangular shaped and is divided into sections to link an iron core of the second rotating member:
wherein, brushless commutatorless operation is produced by said selected operating characteristics of DC motor operation obtained with selected said mode of connection between the stator coil and the at least one armature coil and electrical power applied by said selected mode of providing power to the field coil and the at least one armature coil.

9. The superconducting brushless commutatorless DC electrical motor of claim 1, wherein the first stationary member to produce a magnetic field is in a disc form and a shaft passing there through and the magnetic field is produced by mode selected from group consisting of
a permanent magnet, and
a field coil made from conventional copper conductor to produce a magnetic field.

10. The superconducting brushless commutatorless DC electrical motor of claim 8, wherein the first stationary member to produce a magnetic field is in a cylindrical form and the magnetic iron core is made from low reluctance magnetic iron.

11. The superconducting brushless commutatorless DC electrical motor of claim 1, wherein the first stationary member and first rotating member magnetically link by a magnetic iron core wherein, brushless commutatorless operation is produced by said selected operating characteristics of DC motor operation obtained with selected said mode of connection between the stator coil and the at least one armature coil and electrical power applied by said selected mode of providing power to the field coil and the at least one armature coil.

12. A superconducting brushless commutatorless DC electrical generator, comprising:
a machine housing;
a first rotating member including:
at least one field coil;
a field pole magnetic path; and
a magnetic field;
a first stationary member mounted on the machine housing including:
an armature magnetic path; and
at least one armature coil;
a second rotating member including a plurality of field system yoke magnetic flux conducting paths linking to the first rotating member;
a second stationary member including a plurality of armature yoke magnetic flux conducting paths linking to the second stationary member;
a shaft mounted on the machine housing disposed along an axis around which the first rotating member rotates;
a torque tube assembly to transfer rotational force produced by the shaft to the at least one field coil and provide thermal isolation and heat shield between the field coil and the shaft;
a brushless exciter including at least one brushless exciter armature coil connected to at least one field coil mounted on the shaft, wherein the brushless exciter armature coil magnetically links a stationary brushless exciter field coil when DC power is applied;
a power transfer device configured to transfer power to the first rotating member via a plurality of modes including rotary power transfer device, selected from the group consisting of
(A) a liquid metal rotating contact assembly, having at least one pair of stationary contacts located on the machine housing and at least one pair of rotating contacts located on the shaft wherein the least one pair of stationary contacts located on the machine housing and the at least one pair of rotating contacts located on the shaft are connected electrically by liquid metal and the rotating contacts the further connected to the at least one armature coil,
(B) a rotating transformer, having a primary winding located on the machine housing and a secondary winding located on the shaft and the primary winding located on the machine housing and the secondary winding located on the shaft are connected electromagnetically by transformer action and the secondary winding is further connected to the at least one armature coil utilizing a rectifier and filter circuit,
(C) a brushes and slipring assembly having at least one pair of stationary contacts located on the machine housing and at least one pair of rotating contacts located on the shaft and the at least one pair of stationary contacts located on the machine housing are connected electrically and the rotating contacts are further connected to the at least one armature coil, and
(D) a superconducting rotating transformer having a stationary superconducting primary winding and a rotating superconducting secondary winding having the primary superconducting winding located on the machine housing and the secondary superconducting winding located on the shaft and the superconducting primary winding located on the machine housing and the secondary superconducting winding located on the shaft are connected electromagnetically by transformer action and the secondary superconducting winding is further connected to the at least one armature coil utilizing a rectifier and filter circuit;
a cooling assembly configured to cool the field coil and the armature coil simultaneously in a sealed cryostat at superconducting temperatures by a closed loop cryogenic refrigeration system located outside the motor housing and connected to the cryostat by refrigerant transfer tube and return tube and the cryogenic refrigeration system conducts heat from the rotor coils and stator coil to the cryogenic refrigeration system where the heat is dissipated and the Cryogenic refrigeration system maintains superconducting temperatures inside the cryostat by circulating cryogenic refrigerant at superconducting temperatures where the cryogenic refrigerant keeps the stator coil and the rotor coils in the superconducting state;
wherein the first rotating member and the first stationary member are magnetically coupled to each other by the second rotating member and the second stationary member;
wherein the first rotating member produces a magnetic field in a pattern which links the plurality of coil sides of the first stationary member having coil sides generating electromotive forces, wherein at least one selected coil side comprises, the electromotive force generating main output electromotive forces in the selected direction and polarity and the electromotive forces produced by remainder of the coil sides will be selected from the group consisting of
the coil side generating the electromotive forces in the same direction as the selected coil side,
the coil side generating the electromotive forces in the opposite direction as the selected coil side, and the coil side generating electromotive forces in a direction different from the direction of the electromotive forces generated by the selected coil side without having any effect on the electromotive forces generated by the selected coil side;
Wherein the total electromotive forces generated comprises the electromotive forces generated by the selected coil side and combined effect of the electromotive forces generated by remainder of said coil sides;
wherein the main output electromotive force generated by the selected coil side and combined effect of the electromotive forces generated by remainder of the coil sides produces continuous ripple free electromotive force by commutatorless operation;
wherein an output voltage is able to circulate current in external circuit by brushless commutatorless operation;
wherein a direct current field excitation is applied to the field coils producing DC operation; and
wherein the magnetic field generates a DC voltage.

13. The superconducting brushless commutatorless DC electrical generator of claim 12, wherein the first stationary member and the first rotating member are connected to
each other by mode selected from the group consisting of
at least one armature coil is connected in series with the stator coil,
at least one armature coil is connected in parallel with the stator coil, and
at least one armature coil is connected in series with a series stator coil and connected in parallel with a shunt stator coil,
and in additional mode the excitation source is connected separately to the field coil.

14. The superconducting brushless commutatorless DC electrical generator of claim 12, wherein the at least one armature coil comprises substantially triangular shaped and the plane of the at least one armature coil is parallel to the plane of a field coil wherein the field coil is made from HTS 2G superconducting conductors and supplied with DC excitation voltage separately; and
wherein the field coil is substantially circular shaped:
wherein the field coil is generally concentric with the shaft;
wherein the field coil is located to magnetically link the at least one armature coil made from HTS 2G superconducting conductors; and
a torque tube assembly fabricated from Inconel transfers torque from the shaft to the field coils and a cooling assembly fabricated from a nonmagnetic composite material simultaneously cools the field coil and the armature coils at superconducting temperatures;

15. The superconducting brushless commutatorless DC electrical generator of claim 12, wherein the rotating field comprises at least two field coils facing each other with like polarities and made from HTS 2G superconducting conductors;
the stationary armature coil comprises a substantially triangular shaped coil located between the two rotating coils,
wherein the two field coils are substantially circular shaped;
wherein the two field coils are generally concentric with the shaft;
wherein the two field coils are located to magnetically link the at least one armature coil made from HTS 2G superconducting conductors;
the shaft further comprises a torque tube assembly fabricated from Inconel transfers torque from the armature coils to the shaft and said machine housing comprises the cooling assembly fabricated from a nonmagnetic composite material simultaneously cooling the field coils and the armature coils at superconducting temperatures.

16. The superconducting brushless commutatorless DC electrical generator of claim 12, wherein the first stationary member includes two field coils of like polarity opposing each other and at least one armature coil having a plurality of coil sides with one coil side parallel to an axis of the shaft and perpendicular to the two field coils and two coil sides each parallel to one field coil of like polarity and linking the magnetic field of each coil moving in opposite direction and remainder of armature coil sides includes a plurality of coil side segments form an angle to the sides parallel to each field coil and the plane of coil side segments is perpendicular to each field coil and parallel to the shaft and a torque tube assembly transfers torque from the shaft to the two field coils and the cooling assembly simultaneously cools the two field coils and the armature coil at superconducting temperatures and the flux produced by the two field coils of like polarity travel in opposite directions along the shaft and radially in relation to the shaft interacts with a horizontal armature coil side in a same direction and flux from the two field coils of like polarity moving in a opposite direction simultaneously interacting with two armature coil sides parallel to the field coils generating emf in the opposite direction and the radially moving flux interacts with the coil side segments producing emf and the total emf produced by the coil equals the difference between the sum of emf produced by the side horizontal the axis and the two sides parallel to the two field coils and the emf produced by the two coil segments.

17. A superconducting brushless commutatorless DC linear electrical motor, comprising: a machine housing;
a first stationary member including:
at least one field coil;
a field pole magnetic path mounted on the machine housing; and a magnetic field;
a first linear travel member including:
a linear armature magnetic path; and
at least one linear armature coil having a plurality of coil sides;
a second stationary member including a plurality of field system yoke magnetic flux conducting paths linking to the second stationary member;
a second linear travel member including a plurality of armature yoke magnetic flux conducting paths linking to the second linear travel member;
a linear actuator assembled along the second linear travel member and configured to transfer linear force to a load;
a thermal barrier to transfer the linear force produced by the at least one armature coil to the linear actuator assembly and provide thermal isolation and heat shield between the at least one armature coil and the linear actuator;
a power transfer device configured to transfer power to the first linear travel member by a plurality of modes including linear power transfer device, selected from the group consisting of
a liquid metal linear contacts assembly,
a linear transformer,
a linear brushes and sliding contacts assembly, and
a linear superconducting transformer;
a cooling assembly configured to cool the field coil and the at least one linear armature coil simultaneously in a sealed cryostat at superconducting temperatures by a closed loop cryogenic refrigeration system located outside the motor housing and connected to the cryostat by refrigerant transfer tube and return tube and the cryogenic refrigeration system conducts heat from the linear armature coils and stator coil to the cryogenic refrigeration system where the heat is dissipated and the Cryogenic refrigeration system maintains superconducting temperatures inside the cryostat by circulating cryogenic refrigerant at superconducting temperatures where the cryogenic refrigerant keeps the field coil and the at least one linear armature coils in the superconducting state;
wherein the first stationary member and first linear travel member are magnetically coupled and the second stationary member and second linear travel member are magnetically coupled;
wherein the first stationary member produces a magnetic field in a pattern which links the plurality of coil sides of the at least one linear armature coil of the first linear travel member having coil sides carrying current in different directions such that at least one selected coil side produces a main linear force in a same direction and a remainder of the coil sides producing a linear force in a direction that cancels forces produced by the remainder of the coil sides in an opposite direction to the main linear force preventing the remainder of the coil sides from producing linear force in the opposite direction to the main linear force producing continuous linear force by commutatorless operation;
Where at least one selected coil side comprises, the electromagnetic force generating main driving force on the linear actuator in the selected direction and the electromagnetic force produced by remainder of the coil sides will be selected from the group consisting of the coil side generating force in the same direction as the selected coil side, the coil side generating the force in the opposite direction as the selected coil side, and the coil side generating force in a direction different from the direction of the force generated by the selected coil side without having any effect on torque generated by the selected coil side;
Wherein the total electromagnetic force generating the force on the linear actuator comprises the electromagnetic force generated by the selected coil side and combined effect of the electromagnetic force generated by remainder of the coil sides selected from the above group;
wherein a direct current power is applied to both the field coil and the armature coil;
wherein the magnetic field is produced by a permanent magnet.

18. The superconducting brushless commutatorless DC linear electrical motor of claim 16, wherein the linear armature coil is in a plane parallel to the field coil.

19. The superconducting brushless commutatorless DC linear electrical motor of claim 16, wherein a main driving linear force generates continuous linear motion.

20. The superconducting brushless commutatorless DC linear electrical motor of claim 16, wherein the flux conducting paths are made from flux conducting iron core.
